(19) United States
(12) Patent Application Publication
(10) Pub. No.: US 2006/0168338 A1
(43) Pub. Date: Jul. 27, 2006

(54) Methods and systems for providing data across a network

(76) Inventors: Aaron Ray Bruegl, Brookfield, WI (US); Michael John Hess, Milwaukee, WI (US); Randy Lee Kohlstedt, Oak Creek, WI (US); Scott Benjamin Berger, Franklin, WI (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 11/285,085

(22) Filed: Nov. 23, 2005

Related U.S. Application Data
(60) Provisional application No. 60/630,022, filed on Nov. 23, 2004.

(51) Int. Cl. G06F 15/173

(52) U.S. Cl. 709/240

(57) ABSTRACT

The present invention comprises systems, methods, and means for sending data across a network. Intelligent Image Distributions (IID) systems and methods are also disclosed. Systems, methods, and means for a HawkNet, a transmission control protocol, are likewise disclosed. A description of such systems handling DICOM radiology studies is presented along with a complete system for handling such studies.

### CROSS REFERENCE TO RELATED APPLICATIONS

This application claims the benefit, under 35 U.S.C. § 119, of provisional U.S. Application Ser. No. 60/630,022, filed 23 Nov. 2004, the entire contents and substance of which is hereby incorporated by reference.

### BACKGROUND OF THE INVENTION

Large data files, such as DICOM (digital imaging and communication in medicine) studies, may be sent across a network to geographically dispersed clients or customers. In a DICOM application, these studies may be first received into a technology center through the internet via secure virtual private network (VPN) tunnels. While at the central reading center, these studies may be evaluated for quality and completeness as well as assigned to a radiologist for viewing. Such studies may then be sent to radiologists for viewing and final report processing. A single study may contain a large amount of data and may travel far distances over low bandwidth. Additionally, high latency networks that can take a considerable amount of time to move data from one location to another. Because DICOM studies may be Emergency Room radiology studies, they should preferably be associated with prompt and accurate diagnosis. A need exists to reduce the amount of time it takes to handle, process, and transfer large data files like DICOM studies across a network.

There is a need to develop a system that is capable of receiving increasingly large quantities of data, accessing the data for QC, and sending the data to a user to be examined. The current problems include increased latency of data transfer, the increased volume of data is becoming more inefficient with existing workflow solutions. All data currently needs to be present everywhere, and current software will soon be insufficient to handle the high volumes of data. The successful solution would be to create a system that would control the entire process of receiving the data, displaying the data for QC, and sending the data to the appropriate user. The needed system would reduce the total number of transmissions of an image, and more efficient use of bandwidth. An online configuration system would allow changes to be made to the system quickly and easily, without requiring the user to know advanced computing techniques.

TCP is reliable protocol, but becomes inefficient as network bandwidth and delays increase. These problems are due to slow loss-recovery, a RTT bias inherent in its AIMD congestion-control algorithm, and the bursting data flow caused by its window control. Modern applications that are data intensive applications over high bandwidth delay product networks, such as computational grids, need new transport protocols to support them.

User datagram protocol is a commonly used transport protocol. UDP is a connectionless protocol, meaning that it doesn't guarantee packet delivery or that packets arrive in sequential order. UDP has advantages for less overhead than TCP streaming protocols, and can be used to saturate available network bandwidth to deliver large amounts of data. UDP sockets can receive data from more than one host machine, making it more convenient than TCP.

Transmission Control Protocol is a stream-based method of network communication. It focuses on establishing a connection to control order of packets, and packet loss. TCP uses a lower level of communications protocol, the Internet Protocol (IP), to establish connection between two machines. The connection provides an interface that allows a stream of bytes to be sent and received, and transparently converts the data into IP datagram packets.

What is needed is an internet transport protocol implemented over UDP, meant as a better replacement of TCP. TCP's legacy design carries a number of inefficiencies, the most prominent of which is its inability to utilize most modern links' bandwidth. This problem stems from the fact that TCP calculates the congestion of the channel based on its round-trip time. The round-trip time, however, reflects not only the congestion level, but also the physical length of the connection. This is precisely why TCP is inherently unable to reach optimal speeds on long high-bandwidth connections.

### SUMMARY OF THE INVENTION

The present invention relates to novel systems, methods, and means useful for sending data across a network. In one aspect, the present invention provides for an Intelligent Image Distribution (IID) system for transmitting data across a network comprising at least one proxy server; at least one receive server; and at least one cache server. Wherein the at least one proxy server communicates with at least one receive server across a network and the cache server communicates with at least one receive server across a network. Also, wherein metadata, associated with data, is sent to a receive server from a proxy server; the receive server, based on the metadata, formulates at least one ideal cache server to transmit the data; the data is transmitted to the receive server; and the receive server transmits the metadata and the data to the at least one cache server. The data may be a DICOM study. The proxy server may communicate with at least one receive server across a network via transmission control protocol (TCP) or HawkNet protocol. The above mentioned receive servers may be located at a technology center. A technology center may comprise a plurality of receive servers and a plurality of internal cache servers. This system may also comprise a client module that transmits metadata and data to a proxy server or to a receive server. The system may also comprise the following modules association, statistics, peer, child, intelligence, route, status, study, and configuration modules. The system may also include a destination module that receives data and metadata sent from the cache server or from the receive server. The system may also comprise more than one receive server that are in communication with each other.

The receive server may formulate at least one ideal cache server to transmit the data and/or metadata by considering the following factors: available destinations, number of links, bandwidth, latency, read speed, consistency, reliability, type, destination probability threshold, number of concurrent transfers, current utilized bandwidth, current observed latency, current read speed, current queue status, RIS work-list queue status, RIS work-list queue size, destination arbitrary weight factor, destination load factor, projected queue sizes, projected queue status, and projected system load.

Metadata may include the following data slice ID, series ID, study ID, rescale slope, rescale intercepts, rescale type, patient name, description, study time, study data, receive time, study size, number of bytes, number of slices, intended destination, current location, transfer speeds, destination, clients, IP address, ports, title, destination name, destination ID, client name, and client id.

Another embodiment provides for a method for determining the destination for transmitting data across a network comprising the step of formulating the probability available destinations may be assigned the data by considering factors selected from the group comprising of: available destinations, number of links, bandwidth, latency, read speed, consistency, reliability, type, destination probability threshold, number of concurrent transfers, current utilized bandwidth, current observed latency, current read speed, current queue status, RIS work-list queue status, RIS work-list queue size, destination arbitrary weight factor, destination load factor, projected queue sizes, projected queue status, and projected system load. The data in this method may be a DICOM study.

Another aspect provides a method for transmitting a DICOM study across a network to a destination.

Yet another method of the present invention provides a method for transmitting data across a network comprising receiving a binary data stream; creating a start packet; creating at least one data packet, wherein the number of data packets created is equal to rounding up the number of bytes in the binary data stream (N) divided by the packet size (n); creating a stop packet, and transmitting the start packet, the data packet, and the stop packet to an output socket. Wherein the start packet comprises: a 1 byte value representing the current packet type; a 8 byte value representing the packet number in the data stream; a 8 byte value representing the number of packets in the data stream; a 4 byte value representing the last packet size in the data stream; a 4 byte value representing the ID size; a 4 byte value representing the packet size (n); and a m byte value representing the ID, wherein m is the value represented by the 4 byte ID size value. Wherein the data packet comprises: a 1 byte value representing the current packet type; a 8 byte value representing the packet number in the data stream; and n bytes representing the data, wherein n is the value represented by the 4 byte packet size value in the start packet. Wherein the stop packet comprises: a 1 byte value representing the current packet type; and a 8 byte value representing the packet number in the data stream. The method also comprises the step of receiving acknowledgement packets confirming receipt of each of the data packets.

Yet another aspect provides for system for transmitting data across a network comprising: a receiving module operative to receive a binary data stream; a packetizing module operative to convert the binary data stream into packets comprising the steps of: creating a start packet; creating at least one data packet, wherein the number of data packets created is equal to rounding up the number of bytes in the binary data stream (N) divided by the packet size (n); creating a stop packet, and a transmitting module operative to transmit the start packet, the data packet, and the stop packet across a network. The system may further comprise a send queue, a send controller, and senders. Wherein the start packet comprises: a 1 byte value representing the current packet type; a 8 byte value representing the packet number in the data stream; a 8 byte value representing the number of packets in the data stream; a 4 byte value representing the last packet size in the data stream; a 4 byte value representing the ID size; a 4 byte value representing the packet size (n); and a m byte value representing the ID, wherein m is the value represented by the 4 byte ID size value. Wherein the data packet comprises: a 1 byte value representing the current packet type; a 8 byte value representing the packet number in the data stream; and n bytes representing the data, wherein n is the value represented by the 4 byte packet size value in the start packet. Wherein the stop packet comprises: a 1 byte value representing the current packet type; and a 8 byte value representing the packet number in the data stream.

Another aspect provides for a computer-readable medium having computer-executable instructions for performing a method comprising: receiving a binary data stream; creating a start packet; creating at least one data packets, wherein the number of data packets created is equal to rounding up the number of bytes in the binary data stream (N) divided by the packet size (n); creating a stop packet, and transmitting the start packet, the data packets, and the stop packet out an output socket.

Yet another aspect provides for a computer system, comprising: a CPU; memory; a network interface; and networking means for preparing HawkNet packets. Wherein the networking means further comprises means for transmitting packets across a network.

Another aspect provides for a computer system, comprising: a CPU; memory; a network interface; and networking means for receiving HawkNet packets. Wherein the networking means further comprises means for unpacking received HawkNet packets.

Yet another aspect provides for a method for transmitting a plurality of data packets out a network interface comprising the steps of: creating at least one data packet; transmitting a start packet; transmitting at least one data packet; and transmitting a stop packet.

A further aspect of the present invention provides for a computer system comprising: a CPU; memory; a network interface; and means for communicating across a network with a protocol combines the high throughput of user datagram protocol (UDP) data packets and the reliability of TCP data packets.

Another aspect may provide for a computer system comprising: a CPU; memory; a network interface; and means for transmitting data across a network combines the high throughput of the UDP protocol and the reliability of TCP protocol.

A further method is provided for receiving data from a network comprising: receiving a start packet, receiving one or more data packets; receiving a stop packet, wherein receipt of the stop packet ends the step of receiving data packets; creating a binary data stream by ordering the data in the received data packets according to the packet number in the data packet; and transmitting the binary data stream out an output socket. Wherein the start packet comprises: a 1 byte value representing the current packet type; a 8 byte value representing the packet number in the data stream; a 8 byte value representing the number of packets in the data stream; a 4 byte value representing the last packet size in the data stream; a 4 byte value representing the ID size; a 4 byte value representing the packet size (n); and a m byte value representing the ID, wherein m is the value represented by the 4 byte ID size value. Wherein the data packet comprises: a 1 byte value representing the current packet type; a 8 byte value representing the packet number in the data stream; and n bytes representing the data, wherein n is the value represented by the 4 byte packet size value in the start packet. Wherein the stop packet comprises: a 1 byte value representing the current packet type; and a 8 byte value representing the packet number in the data stream.

Another embodiment of the present invention provides for a computer-readable medium having computer-executable instructions for performing a method comprising receiving a start packet, receiving one or more data packets; receiving a stop packet, wherein receipt of the stop packet ends the step of receiving data packets; creating a binary data stream by ordering the data in the received data packets according to the packet number in the data packet; and transmitting the binary data stream out an output socket.

Another system of the present invention provides for a receiving module operative to receive data packets from a network; a depacketizer module operative to convert data packets into a data stream; and a transmitting module operative to output the binary data stream.

Another aspect provides for a computer system comprising: a CPU; memory; a network interface; and means for adjusting the data rate out a network interface through a learning algorithm that is a function of elements selected from the group comprising of the receiving buffer size, packet loss, estimated bandwidth, current sending rate, number of packets sent during the next ACK timer, round trip time, arrival speed, size of the flow control window, packet size, negative acknowledgment (NACK) packets and bandwidth, buffer size.

A further method of the present invention is provided for transmitting data across a network though multiple links comprising: transmitting an initialization packet; receiving a return initialization packet in response to the initialization packet containing information about the bandwidth, the receive link past history, number of receive links used in the past, the network, and speeds; and setting up additional links based on information from the return initialization packet.

Another method is provided for receiving data from a network through multiple links comprising of: receiving a data stream; creating packets from the data stream; placing packets in a queue; and transmitting packets through multiple links.

Yet another method is provided for receiving data transmitted across a network through multiple links comprising of: receiving data packets; transmitting an acknowledgement (ACK) packet in response to the data packet; placing packets in a queue; creating a data stream from the packets; and transmitting the data stream.

### BRIEF DESCRIPTION OF THE DRAWINGS

FIG. 1 depicts a diagram of the login flow of the DICOM Viewer.

FIG. 2 depicts a diagram of the logged in flow of the DICOM Viewer.

FIG. 3 depicts a diagram of the QC flow study.

FIG. 4 depicts a computer screen view of the DICOM Viewer Web Link.

FIG. 5 depicts a computer screen view of the DICOM Viewer in logged off mode with location select box open.

FIG. 6 depicts a computer screen view of the DICOM Viewer with login mode.

FIG. 7 depicts a computer screen view of the DICOM Viewer in logged in mode.

FIG. 8 depicts a computer screen view of the DICOM Viewer with study open for QC.

FIG. 9 depicts an embodiment of the present invention entitled, for convenience, Intelligent Image Distribution (IID).

FIG. 10 depicts a diagram of the IID Configuration Flow.

FIG. 11 depicts a computer screen view of the IID log server monitor.

FIG. 12 depicts a computer screen view of the IID log viewer.

FIG. 13 depicts a computer screen view of the IID configuration viewer.

FIG. 14 depicts a computer screen view of the IID cleanup mode.

FIG. 15 is an overview of an embodiment of the invention named, for convenience “HawkNet.”

FIG. 16 represents a single HawkNet start packet.

FIG. 17 represents a single HawkNet data packet.

FIG. 18 represents a single HawkNet stop packet.

FIG. 19 represents a single HawkNet acknowledgement (ACK) packet.

FIG. 20 represents a single HawkNet negative acknowledgement (NACK) packet.

FIG. 21 is another representation of an embodiment of a HawkNet system

FIG. 22 shows a sample data stream.

FIG. 23 is a sample start packet.

FIG. 24 is a sample first data packet.

FIG. 25 is a sample last data packet.

FIG. 26 is a sample stop packet.

FIG. 27 shows a systems congestion control.

FIG. 28 shows a packet sending period.

FIG. 29 shows a system sending a packet pair to calculate link capacity.

FIG. 30 shows a flow control window prior to receiving an ACK packet.

FIG. 31 shows a flow control window after receiving an ACK packet.

### DETAILED DESCRIPTION OF EMBODIMENTS OF THE PRESENT INVENTION

The embodiments of the present invention support the routing, sending, receiving, or transmitting data across a network with a variety of systems. For example, Intelligent Image Distribution (IID) and HawkNet are two such systems.

In one embodiment of the present invention, HawkNet is an application level protocol built upon the user datagram protocol. Hawk Net facilitates high volume flow needed for transferring data across large distances. Hawk Net will also provide high utilization of bandwidth through its congestion control algorithm. HawkNet is also implemented entirely using the latest Java technology, which provides cross platform compatibility.

Hawk Net combines the speed of user datagram protocol (UDP) transmission and reliability of the popular transmission control protocol (TCP). Performance with the Hawk Net protocol will be faster than TCP, and more reliable than UDP. Hawk Net will remain fair, and friendly to transfers.

HawkNet's congestion control mechanism that maintains efficiency, fairness and stability, and its application-level nature enable it to be deployed at low cost, without any changes in the network infrastructure or operating systems.

TCP is reliable protocol, but becomes inefficient as network bandwidth and delays increase. These problems are due to slow loss-recovery, a RTT bias inherent in its AIMD congestion-control algorithm, and the bursting data flow caused by its window control. Modern applications that are data intensive applications over high bandwidth delay product networks, such as computational grids, need new transport protocols to support them.

User datagram protocol is a commonly used transport protocol. UDP is a connectionless protocol, meaning that it doesn't guarantee packet delivery or that packets arrive in sequential order. UDP has advantages for less overhead than TCP streaming protocols, and can be used to saturate available network bandwidth to deliver large amounts of data. UDP sockets can receive data from more than one host machine, making it more convenient than TCP.

Transmission Control Protocol is a stream-based method of network communication. It focuses on establishing a connection to control order of packets, and packet loss. TCP uses a lower level of communications protocol, the Internet Protocol (IP), to establish connection between two machines. The connection provides an interface that allows a stream of bytes to be sent and received, and transparently converts the data into IP datagram packets.

Hawk Net is an internet transport protocol implemented over UDP, meant as a better replacement of TCP. TCP's legacy design carries a number of inefficiencies, the most prominent of which is its inability to utilize most modern links' bandwidth. This problem stems from the fact that TCP calculates the congestion of the channel based on its round-trip time. The round-trip time, however, reflects not only the congestion level, but also the physical length of the connection. This is precisely why TCP is inherently unable to reach optimal speeds on long high-bandwidth connections.

The IID Service is a specialized data transfer system. The data it receives promptly is validated, indexed, recompressed, and prepared for remote viewing. Low latency, high throughput, and enhanced reliability are the primary goals for the service, so it is able to scale to handle the load, while providing little interruption in common failure situations.

Each IID Service instance is able to communicate configuration and workflow data changes to other IID Service instances using a common local database and/or via a direct communication interface. Data storage is based off of a shared NAS solution, with each service instance having access to all data. The use of common data storage solutions provide a straightforward upgrade path for performance and reliability, along with providing redundant access to data processed by an individual instance. An IID Service instance may be shutdown without affecting the overall operation of other instances.

Data reformatting and recompression are extremely important to the successful flow of data through the IID Service. Properly compressed data is more efficiently transferred over bandwidth constrained connections, and also has a greater chance of being correctly interpreted by other software. Proper formatting of data may be in the form of an industry wide standard, such as DICOM 3.0 or JPEG.

The configuration of IID is done through a direct communication configuration interface, and all changes are immediately reflected in the database. Since each IID Service instance is configured through the database, all aspects of the IID Service (i.e. global settings, server settings, boot settings, etc) can be configured from a single point of entry. A configuration client is able to connect to the IID Service via an RPC interface.

The IID Service provides an RPC control interface to allow a QC user with a client viewer to properly examine, modify, and send data currently within the workflow. Changes to the indexed data are pushed out to connected clients as they occur, so polling does not have to occur. Only indexed and compressed data are available for a client viewer, so all sending takes place within the IID Service.

The IID Service provides an intelligent data routing algorithm. All data that has been received and processed is inspected and tagged with a list of possible destinations. Each destination is given a probability based off of pre-determined weights and current running statistics. All destinations with a probability greater than a certain threshold are then sent the data. When the final send is communicated from the QC user, the algorithm is notified of the correct destination. Any errors made will be recorded, and may be included with the probability calculation.

The IID Service is able to compress data using multiple techniques. Images, for example, may be compressed using appropriate image compression protocols. Protocols like JPEG, JPEG 2000 and PNG all have the ability to reduce the storage size, without reducing image quality.

The invention may be used by several users including but not limited to Quality Control (QC) team member, Pre-QC team member, an IT team member, radiologist, and hospital technician.

The present invention has several advantages including reduced image transfer times for in-network transfers, reduced network bandwidth requirements, increased efficiency for the QC workflow, remote QC capability, increased failover capability, straightforward configuration, consistent data formatting, real-time transfer status monitoring, and intelligent data forwarding.

In some embodiments, the system may be able to communicate with DICOM 3.0 compliant peers. The IID System may be able to interact with DICOM 3.0 compliant peers. This includes DICOM Gateways and Modalities. The system may be able to provide send and receive DICOM studies, along with providing a Query/Retrieve interface.

In some embodiments, the system may be able to communicate with other IID systems. There may be many different IID servers that are part of the same network and there may be IID systems deployed on WAN links. Each server and each system may be able to efficiently communicate with each other, using the most efficient method available to both systems. New versions of IID may be able to communicate with older versions of IID.

In some embodiments, the system must be fault tolerant, and redundant. The IID system may gracefully handle a server crash or a hardware failure with as little interruption of service as possible. This includes having multiple, load-balanced and redundant IID Receive servers, having fault tolerant storage and network solutions, and having a high speed online backup system. It also may require each IID Receive server to use a common data store.

In some embodiments, the system must use an ACID compliant database for critical information storage. The IID system must have access to a fault-tolerant ACID compliant database for metadata storage. Metadata includes study information, fax information, configuration information, etc. Image data will not be stored within the database.

In some embodiments, the system may employ a real-time backup system. Information not exclusively stored with the database may be stored on a real-time backup system. This will primarily be DICOM formatted image sets.

In some embodiments, the system may be able to efficiently transfer DICOM studies. The IID system may provide efficient communication protocols, with the ability to transfer studies over high-latency, high loss, high capacity network links. This includes choosing the most appropriate method for DICOM 3.0 transfers, and choosing the most efficient proprietary transfer method when communicating with other IID systems.

In some embodiments, the system may provide a GUI configuration tool. The GUI configuration tool allows the IT Team Member to make configuration changes to the IID System.

In some embodiments, the system may be a distributed system allowing multiple simultaneous users. The IID system may support multiple clients accessing the system simultaneously. This includes multiple senders, multiple receivers, and multiple QC Team Members. Access to the system is via DICOM 3.0 compliance, and using RPC from one of the tools provided.

In some embodiments, the system may provide a GUI QC tool. The IID system may provide a GUI based tool that assists a QC Team Member in their workflow. DICOM studies may be viewable, using image window levels and advanced scrolling techniques. Fax transmissions may be viewable with zoom and panning. A global work list may be provided that will promote a fair and efficient workflow within the QC Team. A QC Team Member may be able to send a specific study to a destination. DICOM studies may be marked for splitting apart or merging.

In some embodiments, the system may communicate using secure methods. All information contained within IID may be secure. Any communication that occurs outside the Nighthawk Radiology Services corporate network may be strongly encrypted. Any communication that occurs inside the corporate network may be accessible only to users with sufficient privileges.

In some embodiments, the system may use an RPC interface for communication with remote clients. Tools written for the IID systems may use an RPC interface for primary methods of communication. RMI may be used to fulfill this need initially.

In some embodiments, the system may be able to merge DICOM studies. The system may be able to receive a command telling what studies to merge, and what study may be the primary study. It may then move the Data files and change the DICOM Instance ID of all secondary studies to match the primary study ID, and update the data store with the merged information.

In some embodiments, the system may be able to split DICOM studies. The system may be able to receive a command telling how to split a DICOM study. It may generate new, unique DICOM Instance IDs for all split studies.

In some embodiments, the system may be able to queue DICOM study transfers for efficient use of bandwidth. The system may fairly treat each transfer in the order it was issued. If a transfer is currently taking place, any further transfers may be queued, allowing the current transfer to completely as soon as possible. The system may also provide priorities for each study, allowing higher priority studies to be transferred before lower priority studies.

In some embodiments, the system may be able to use any stream-compatible socket for communication. The system may be able to use any form of socket communication provided by the host system. TCP/IP may be the primary form of communication for a DICOM 3.0 compliant device.

In some embodiments, the system may be capable of sending multiple DICOM studies simultaneously to a destination. Multiple simultaneous sends may be possible.

In some embodiments, the system may include an IID Receive Server. The IID Receive server may be the central point for the entire IID system. Current DICOM studies, queues, configuration, etc. may be all contained within the IID Receive server. The entire IID System may contain multiple IID Receive Servers, all of which may share the same database for information and configuration storage. The IID Service may initially consist only of the IID Receive Server.

In some embodiments, the system may include an IID Cache Server. The IID Cache server may be an IID server that resides close to DICOM image destinations. The primary intent of the IID Cache server may be to allow proprietary data transfers over WAN links to decrease transfer times. The IID Cache server may be built from components of the IID Receive Server

In some embodiments, the system may include an IID Gateway Server. The IID Gateway server may be an IID server that resides close to DICOM image sources. The primary intent of the IID Cache server may be to allow proprietary data transfers over WAN links to decrease transfer times. The IID Cache server may be built from components of the IID Receive Server

In some embodiments, the system may be able to auto-forward data to pre-determined destinations Each IID System may have a set of rules that may automatically forward all data that matches certain criteria to pre-determined destinations. Rules may be configurable, and changes may occur in real time.

In some embodiments, the system may be able to intelligently forward data to probable destinations. The IID Receive server may have the ability to efficiently forward data to destinations that may need the data at some point in the future. Destinations may intelligently be selected based on working parameters, predetermined weights, and prediction history.

In some embodiments, the system may be able to properly compress data Each IID server may be able to compress data using an appropriate compression scheme. Images, for example, may be compressed using a variety of compression protocols. Compression parameters must be editable at runtime.

The system of the invention may use any operating system (OS) capable of running a Java 1.5.0 Virtual machine. Examples of such OS include but not limited to Fedora Core 4, Microsoft Windows XP, Microsoft Windows Server 2003, etc. The system of the invention may use multiple configurations of hardware. One such configuration for the IID Receive Server may be as follows: 2 GB of System Memory; 300 GB of Storage available for DICOM Study Information; 200 GB of Storage available for indexed images; 2.8 GHz (or equivalent) processor; 2 Gigabit network interfaces (General Data Send/Receive; Web/RMI interface). One such configuration for the IID Cache Server may be as follows: 1 GB System memory; 50 GB of Storage available for DICOM Study Information; 2.0 GHz (or equivalent) processor; Multiple network interfaces (One per network/internet link). One such configuration for the IID Gateway Server may be as follows: 1 GB System memory; 100 GB of Storage available for DICOM Study Information; 3.2 GHz (or equivalent) processor; Reliable network interface. The system of the invention may use software on IID server as follows: Java 1.5.0 JVM; Java Advanced Imaging (JAI) 1.1.2.01; Java Advanced Imaging I/O (JAI/IO) toolkit 1.0.01; Web server (Apache, or equivalent).

The entire IID system may be able to handle all DICOM image traffic that Nighthawk Radiology Services requires. For example, that may be between 2,000-3,000 DICOM studies per night, averaging 75-150 slices per study. The current system may peak at about 400 DICOM studies per hour. The QC Team Members may not have any significant delays in any action that they perform. All actions that are triggered by a Nighthawk Radiology Services employee may be fast and responsive, at all times of the day. Online help may be provided. IID Receive servers run processes that may have a console based interface.

In one embodiment, the system has the Intelligent Image Distribution (IID) DICOM Viewer. The purpose of the IID DICOM Viewer may be to provide a user interface for IID receive servers so that a Quality Control Tech Assistant may view and control studies residing the said IID servers. The IID DICOM Viewer may provide the ability to connect to IID servers so that studies can be viewed. Viewing studies may entail displaying a table of studies where each row represents a study, and the columns display various fields from the study. When a study is selected from the study table, it may be set as the current study and displayed by the following means: thumbnails of all slices images may be displayed, the currently selected slice image may be displayed, and study details are displayed. Studies may be controlled by either sending them or saving them. Each IID DICOM Viewer may receives updates from an IID Receive Server that causes modifications performed by other QC Tech Assistants to be reflected in all IID DICOM Viewer clients.

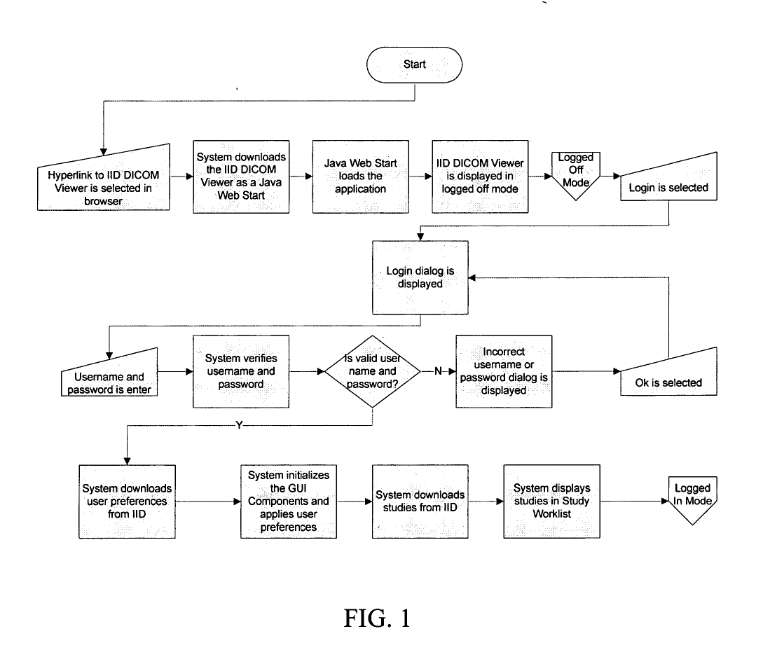

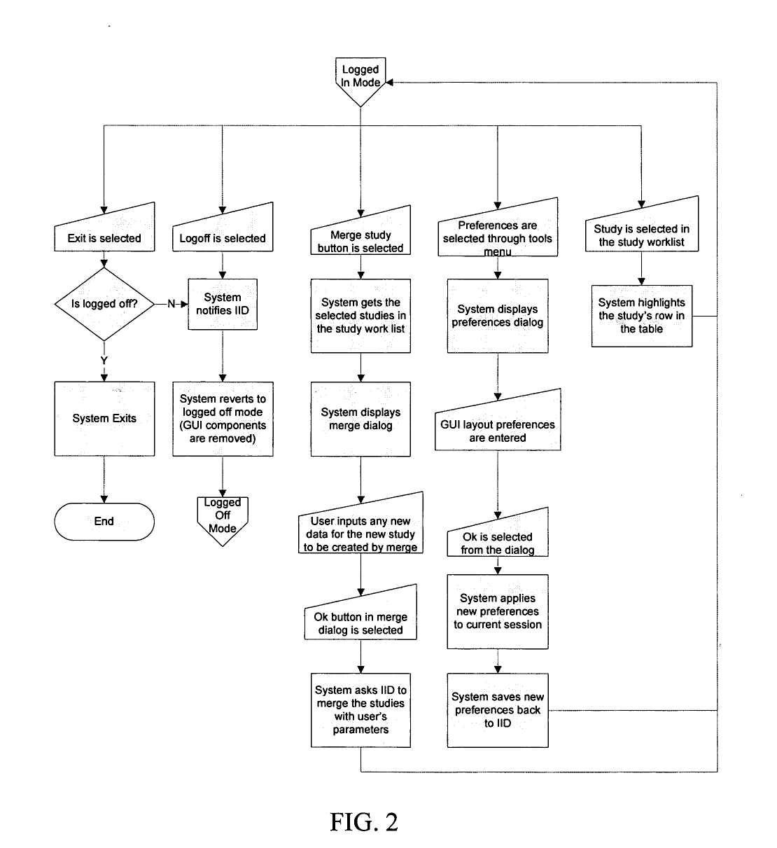

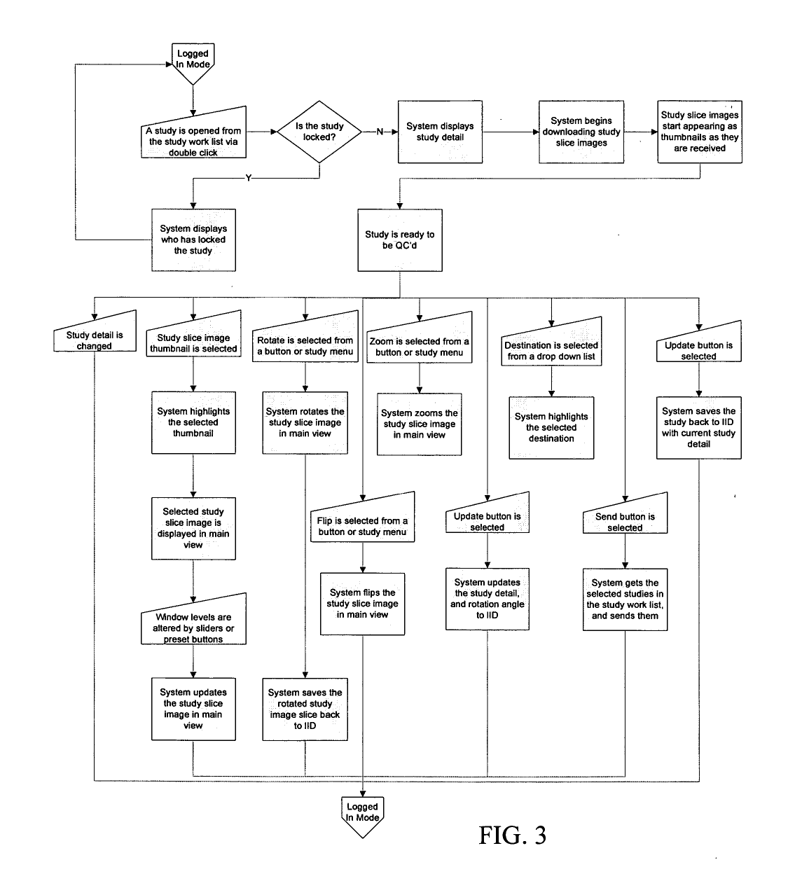

The following FIG. 1, FIG. 2 and FIG. 3 show the basic flow of the DICOM Viewer from opening the application to exiting. They also describe the basic flow a QC Tech Assistant would follow when QCing a study.

In some embodiments, the IID DICOM Viewer may be designed to be a simple and powerful application that may serve the purpose providing a visual interface to IID so that a QC Tech Assistant can perform QC reads of Studies and faxes. The DICOM Viewer may be designed to be a web application so that product updates are automatically pushed out to users. The DICOM viewer may have a customizable user interface that includes several main visual sections when working with Studies.

In some embodiments, a Studies Worklist may reside on IID Servers in a table format. The table may be sorted and filtered. Studies may be selected in order to be sent or opened and may manually display all DICOM information. The Studies may be classified as ignore/unignore. In some embodiments, a Study Image Thumbnails may display the Slice images as thumbnails when a Study is opened. Thumbnails may be selected to display the Study Slice Image. Multiple thumbnails may be selected manually, or by series. The currently selected Study Slice Image(s) may be highlighted in red. In some embodiments, a Study Slice Image may display a large view of the current Study Slice Image and may display additional image and Slice information in an image text overlay. In some embodiments, a Study Detail may display the Study detail data of the currently open Study, which are editable. In some embodiments, a Study Control may change the window width and level for the Study Slice Image in Hounsfield units. The Study Slice Images may be flipped, rotated, translated, and zoomed and may have a cine slider to cycle through the opened Study's Slice images automatically or manually. It may update a Study when the Study Details may have changed. Studies or Slices may be split, merged, and sent to a destination.

Each user may set visual and functional preferences which are restored when loading the application. This allows the user to have a consistent and predictable user experience with each use. The DICOM Viewer may be designed to be a web application so that product updates are automatically pushed out to users.

In one aspect of the invention, the DICOM Viewer may have one or more features including but not limited to Login, Set GUI Preferences, View Open Study, Sort Studies, Filter Studies, Select Study Slice, Open Study, Set Window Level/Width of Slice Image. In the Login feature, the QC Tech Assistant may required to supply a username and password to log into the viewer. By logging on, the QC Tech Assistant's user preferences are loaded, connection to IID Receive Servers may be established, and Studies may be downloaded from the IID Receive Servers. In the Set GUI Preferences feature, GUI preferences may be set through a configuration dialog, may be saved by the QC Tech Assistant or saved automatically upon exit. In the View Open Study feature, Viewing Opening a Study may be done by opening the Study through the Studies Worklist. When the QC Tech Assistant double clicks on a Study in the Studies Worklist, it may be opened by loading the study images, displaying the slice image thumbnails, displaying the first study slice image, and displaying the Study detail. In Sort Studies feature, Sorting Studies is done in the Studies Worklist. This may be done by standard table sorting, clicking on the table columns to specify sorting order. In Filter Studies feature, Filtering Studies may be done in the Studies Worklist. A filter may be typed in a field and applied to the table in the Studies Worklist. Other methods of filtering may also be employed. In Select Study Slice feature, Slice selection may be for selecting a Slice Image from an open Study and displaying it as the Study Slice Image. Selecting a slice may be done by two different methods, either by selecting the Slice image thumbnail or changing the cine slider position. In Open Study feature, Opening a Study may be done through the Studies Worklist. A double click on a study in the table may result in the Study being opened. When a Study is open, its thumbnails, slice image, and study details may be displayed. This is one way a Study may have its detail information changed and updated. In Set Window Level/Width of Slice Image feature, Window Widths/Levels may be applied to the Study Slice Image. Setting the Window Width and Level may be done through two different methods: manipulation of slider bars for each value and buttons with preset values for standard window levels and widths. These preset window levels and widths are: Brain, Bone, Liver, Lung, and Angio, and Automatic. In Move/Set Visible Study Columns, Columns in the Studies Worklist may be moved by dragging the column with the mouse and can be set visible through a configuration dialog.

In some aspects of the invention, the DICOM Viewer may have one or more features including but not limited to load studies and faxes, load study images, manipulate image, select study, select radiologist destination, control study, send study, send slices, split study, send study data, update study, open study, send slices, ignore/unignore studies, view study history. In the load studies and faxes feature, studies and faxes may be loaded from IID Receive Servers and may be placed in the Studies Worklist and Fax Worklist. Loading Studies and faxes may occur when the QC Tech Assistant logs on and periodically Studies and faxes may be pushed out to the Viewer from IID Receive Servers as they are received. In the Load Study Images feature, loading study images may be done upon opening a Study from the Studies Worklist. The Slice images may pulled from the IID Receive Servers. In the Manipulate Image feature, other than window leveling, standard image manipulation may be provided for the Study Slice Image. Such image manipulations may be: flip, rotate, translate, invert, and zoom. In the Select Study feature, studies may be selected in the Studies Worklist by clicking on the study row. Selected Studies may be used when Studies are sent to a destination. In the Select Radiologist Destination feature, a list of destinations may be provided for sending studies. In the Control Study feature, controlling studies may involve any manipulation of Study data that can be changed. This may involve: sending a Study, splitting up a Study, setting Study data, updating a Study, locking a Study, unlocking a Study, and merging Studies. In the Send Study feature, send study may send the currently selected Studies in the Studies Worklist to the currently selected destination or user. In the Send Slices feature. the slices that have been selected in the Slice Image thumbnail panel may be sent to the currently selected destination or user. In the Split Study feature, a Study may be split up into two or more new Studies while retaining the original Study. In the Set Study Data feature, the Study data may be set through the Study Detail. In the Update Study feature, a Study may be updated (back to the originating IID Receive Server) when its data has been changed. In the Open Study feature, opening a fax may be done through the Fax Worklist. A double click on a fax in the table may result in the fax being opened. When a fax is open, its thumbnails, fax page image, and fax details may be displayed. This is only one way a fax may have its detail information changed and updated. In the Ignore/Unignore Studies feature, a Study may have its state set to ignored or may be unignored by right-clicking a Study in the Studies Worklist and selecting the appropriate menu option. This changed state may be viewed by other QC Tech Assistants and may also be used as a basis for filtering studies. In the View Study History feature, a user may view a Study's history by right-clicking a Study in the Studies Worklist and selecting the appropriate menu option. This may show information such as where and when the Study was sent and when the state was changed.

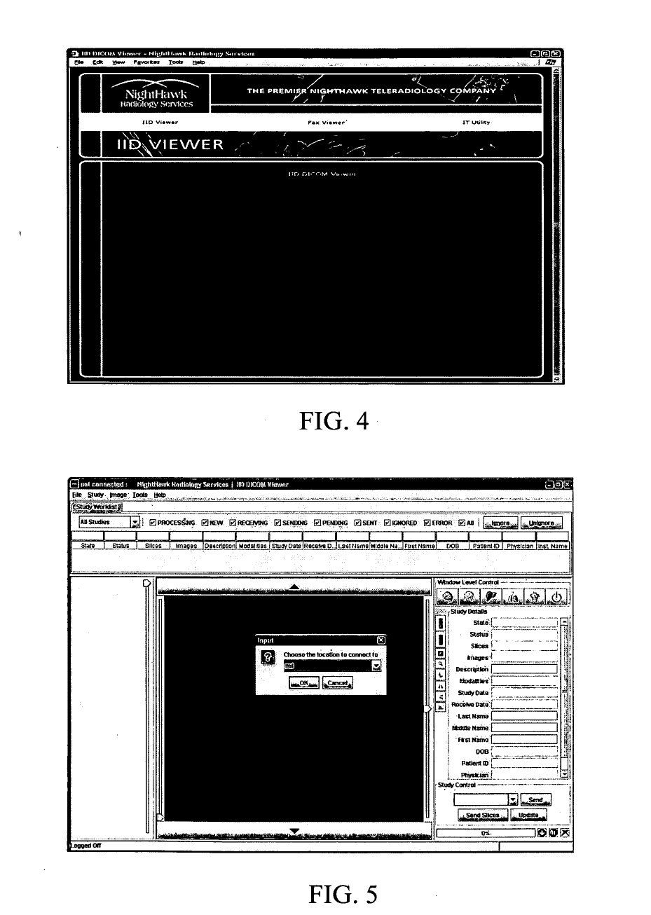

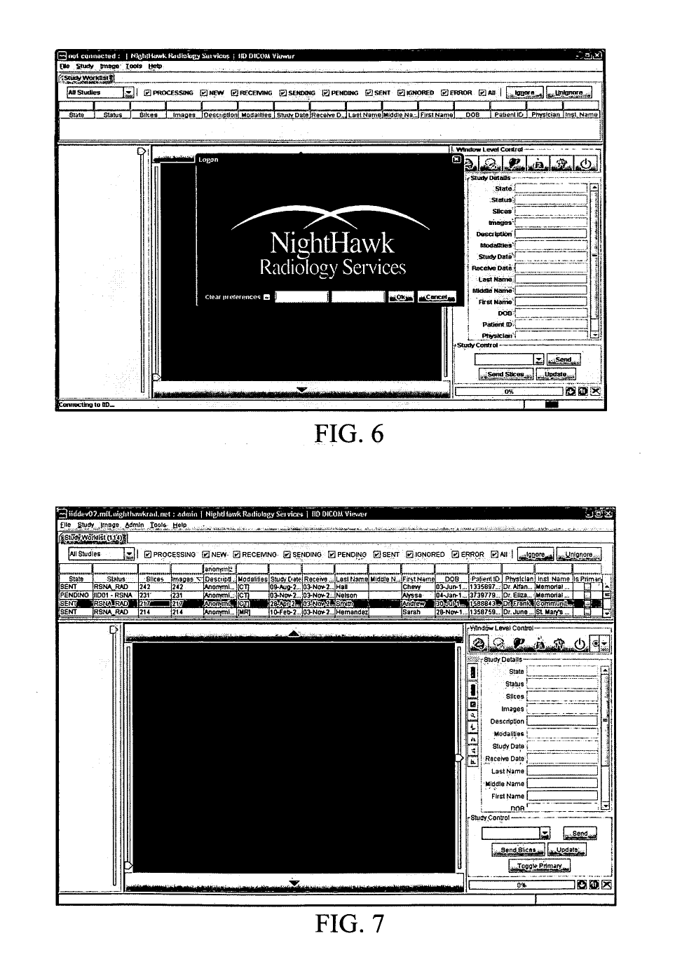

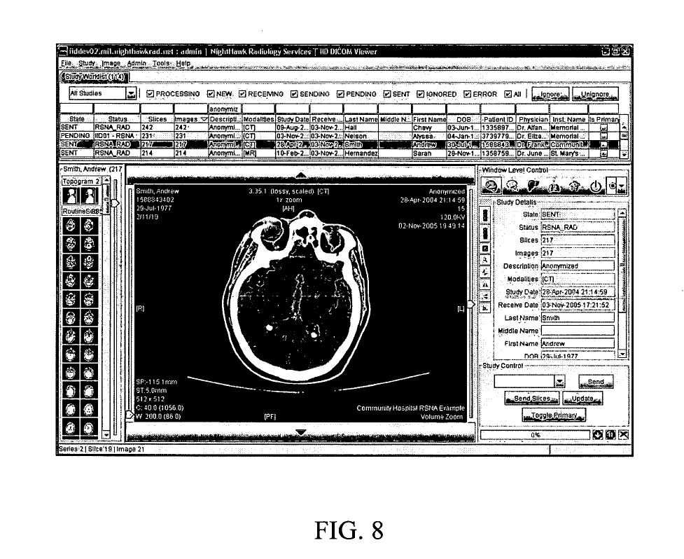

In some aspects of the invention, the DICOM Viewer may have one or more features including but not limited to view DICOM information, support Dynamic Image Downloading, Support Image Formats, and Support Integration with Other Software Systems. In the View DICOM Information feature, A user may view all of a selected Study's DICOM information by using the appropriate hotkey. In the Support Dynamic Image Downloading feature, the IID DICOM Viewer may be able to utilize multiple simultaneous downloaders to quickly download DICOM Slice images. It also may enable users to pause, resume, and cancel the loading of a Study's images. In the Support Image Formats feature, the IID DICOM Viewer design may include being flexible with respect to which formats Study Slice images may be loaded from. It also may support adding support for additional formats,. Some formats include but are not limited to PNG, TIFF, JPEG, and JPEG2000. The IID DICOM Viewer may be able to integrate with other software systems to extend the benefits to its users. FIGS. 4-8 show that the DICOM Viewer is a web application.

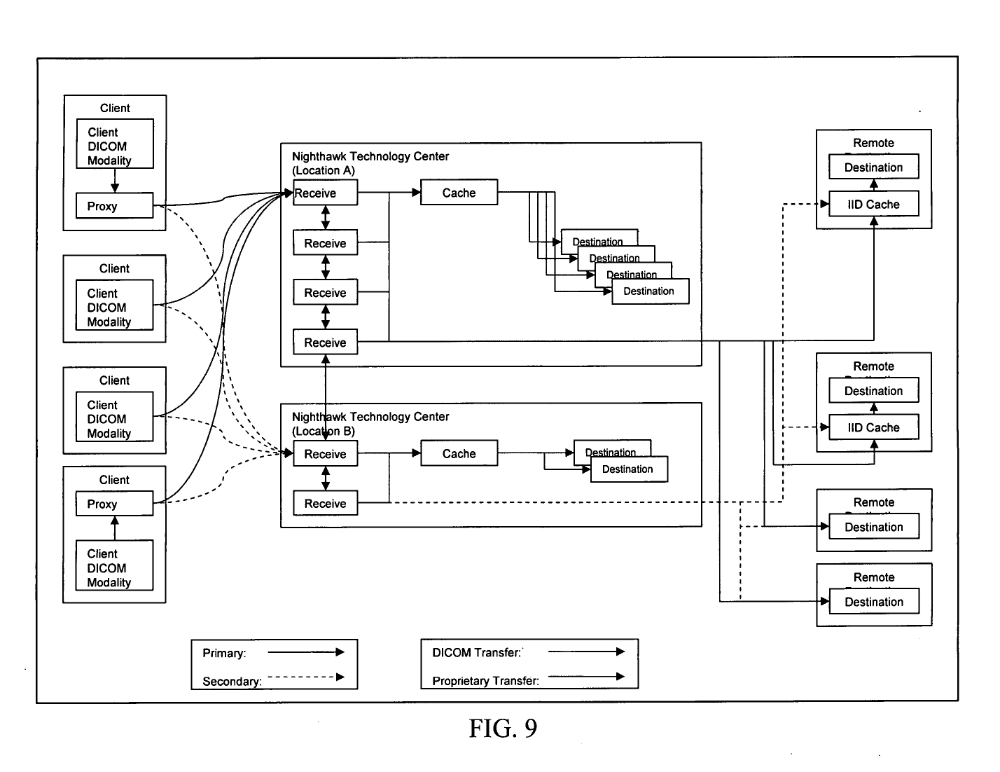

FIG. 9 shows a system for routing Digital Imaging and Communications in Medicine (DICOM) studies across a network. The use of DICOM studies to describe the embodiments of the present invention is exemplary only. Any data type or file may be used without deviating from the spirit of the present invention. Because of their large size, DICOM studies are a good example for discussion. DICOM studies are preferably large radiological image files. These studies, for example, may be captured at a hospital and sent over a network to a radiologist for diagnosis. Often, time is critical and the health of a patient may hinge on a timely diagnosis. The system depicted in FIG. 9, from left to right, shows four clients, two technology centers and four destinations. Each client at a minimum has a client module (Client DICOM Modality) that sends the DICOM file across a network to a waiting radiologist for diagnosis. The client may also include a proxy server (IID proxy). A technology center may have at least one receive server (IID receive) which is the controller or “brains” of the system. The receive server intelligently predicts the most probable destinations for the DICOM study by considering a number of factors that will be discussed below.

In one embodiment, DICOM data flows through the system as follows. A DICOM study may be sent from the client module to the proxy server across a local area network (LAN). The proxy server forwards metadata associated with the DICOM study to the receive server. The receive server predicts the most probable destinations for the study to be routed to. While the receive server is making this prediction, the DICOM study may be sent from the proxy server to the receive server. Once the most probable destinations are known and the study is received by the receive server, the study may be sent to at least one of the most probable destinations. In this embodiment, the destination may be reached through a cache server. In some embodiments, the proxy and/or cache servers may be skipped and data may be sent directly to and from the receive server.

The cache server may be used to store the DICOM study until the study may be assigned a specific destination. Because studies are sent to the most probable destinations, more than one destination may receive a study, but only one destination will be assigned the study. Because a destination and a cache server often exist on a LAN, data transfer between the two preferably occur at high speeds. To speed up transmission the study may be sent to the destinations most likely to be assigned the study. One embodiment of the cache server holds the study until an assignment is made and the release the study to the assigned destination only. Because destinations and cache servers may be housed on a local area network (LAN) the transmission time may be very short in comparison with network wide transmissions.

In another embodiment, the destination and/or cache server may be located on a LAN connected to the receive server within the technology center.

In another embodiment, two technology centers may be may be utilized. This provides redundancy in the event of a network failure or other problems. In such an embodiment, the receive servers between the technology centers communicate and share data.

In another embodiment of the present invention, the controller for the proxy server may be the entry point for the IID proxy application and may handle all of the overall capabilities of the server. A boot order may be defined that specifies module creation and applies configuration to the appropriate modules. When the modules are created, interconnections between the modules are made by the proxy controller. After the connections are made, the modules may then be started by the controller. Tracking IID receive servers involves, for example, maintaining a list of preferred servers, which are updated at regular intervals. Exception logging may also be maintained for connection failures.

In another embodiment, the receive controller is the main entry point for receiving an application. A peer server may be part of the backbone of the IID System, providing the main DICOM storage, study information storage, server synchronization, intelligent routing, and much more.

In yet another embodiment, the cache controller module may be the main entry point for the IID cache application. A cache server may be an important part of the study pre-loading that the IID intelligence module is designed to achieve.

In one specific embodiment, the IID System receives studies from any DICOM compliant peer, and “intelligently” transfer the studies to the locations where they are most likely needed. The system may also provide a streamlined approach for the Quality Control (QC) team, by providing a lightweight viewer that uses a shared work list, and displays reduced size images intended solely for the purpose of ensuring that the study is intact and that it has been ordered with the appropriate level of priority. During the time that a study is being examined by the QC team, the IID System may attempt to make an intelligent decision as to what the final destination of the study will be. This decision may be made based on many factors; including, but not limited to: current radiologists logged into the system with the appropriate hospital credentials and state licenses, study size, destination queue size, destination read rate, transfer speed, physical location, and destination capabilities.

To achieve an extremely stable and fast system, a load balanced, redundant server setup may be used. Servers may be configured in a peer to peer setup, communicating with each other on an as needed basis.

Most DICOM compliant hardware does not efficiently transfer DICOM data over high latency connections, so part of the IID system will reside very near the client. This part of the system, the IID Proxy server, will have the primary responsibility of quickly receiving the DICOM images from the clients DICOM compliant peer, and transferring the images to the IID Servers located at the central technology centers via a more efficient data transfer protocol, such as that embodied in “HawkNet,” described herein. One such technology center is the referred to herein as “Nighthawk” technology center.

In another embodiment, a DICOM peer initiates and completes a send to the IID Systems DICOM receive port, either on the IID Proxy server at the client's location, or to an IID Peer Server in the Nighthawk technology center. During the progress of the send, the images of the DICOM study may be stored as DICOM compliant files on the servers local file system, and study metadata may be stored in a data-store on the IID Server.

If the server that received the study is an IID proxy server, it then sends the study to an IID peer server in a Nighthawk technology center. The images in the study are checked and converted to a standardized format, and then transferred to the IID peer server.

When the study is received on the IID Peer server, either from a peer or an IID proxy server, the study may be persisted to disk in a structured directory tree, and the data-store may be notified of the location. Upon notification, the data-store may create standardization commands, which may be queued up for execution. A command processor can process each command, verifying the storage format, and converting images that are not in the IID standard format. Upon verification of the files, the data-store may once again be notified, and issues another command to extract the image data from the study, scale it, compress it, and store it in a web enabled location on the server. The stored image is smaller and more efficient for network transfers, and can be in any image format known to the server. These images may be used for lightweight java viewing.

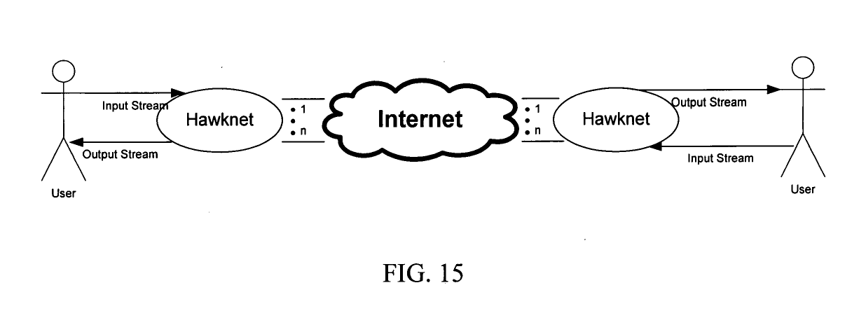

In one embodiment, each server, the proxy server, receive server, and the cache server, may be comprised from a number of modules. The functionality and interrelationship of each module will be described below. For example, the proxy server may be comprised from the association, child, configuration, route, status, and image modules; the receive server may be comprised from the association, peer, configuration, route, status, image, and intelligence modules; and the cache server may be comprised of the association, child, configuration, route, status, and image modules. FIG. 15 shows how each of these modules interrelates.

Association Module

Another embodiment includes the association module. The association module may be responsible for all DICOM communications. It sends and receives data from compliant peers, such as proxy servers, receive servers, and cache servers. Transfers need a reliable, low level connection protocol. Several protocols match this definition, including TCP/IP or “HawkNet.”

The association module may be created using the strategy design pattern. The association context may be responsible for establishing associations, and it may make a decision as to what method of transfer will be used. For example, it may choose between TCP/IP and HawkNet protocols. The strategies that are created may be dependent on the popularity of the peers in which the system interacts. In one embodiment the most important strategy will be the generic DICOM transfer protocol, which will allow the application to form an association and interact with any DICOM 3.0 compliant peer.

In another embodiment, the Association module may also have an active listener on a port and AE_TITLE specified in the configuration module. When a low level connection is formed with a listener, the association module passes the connection to the association strategy, which then forms the association and enables DICOM request processing to take place.

When a module requests an association to send to a particular destination, the association module firsts establishes a low level connection with the remote host on the specified port and then hands the connection to the appropriate strategy. The strategy may then negotiate the appropriate communication parameters, and may be available for sending and receiving commands.

An Association strategy may use a command design pattern to handle the incoming DICOM commands and has flyweight command handlers that handle the commands. Each handler has appropriate connections to the modules needed for the DICOM command involved.

In another embodiment errors may be handled in the association strategy, and errors are logged to the Status module appropriately.

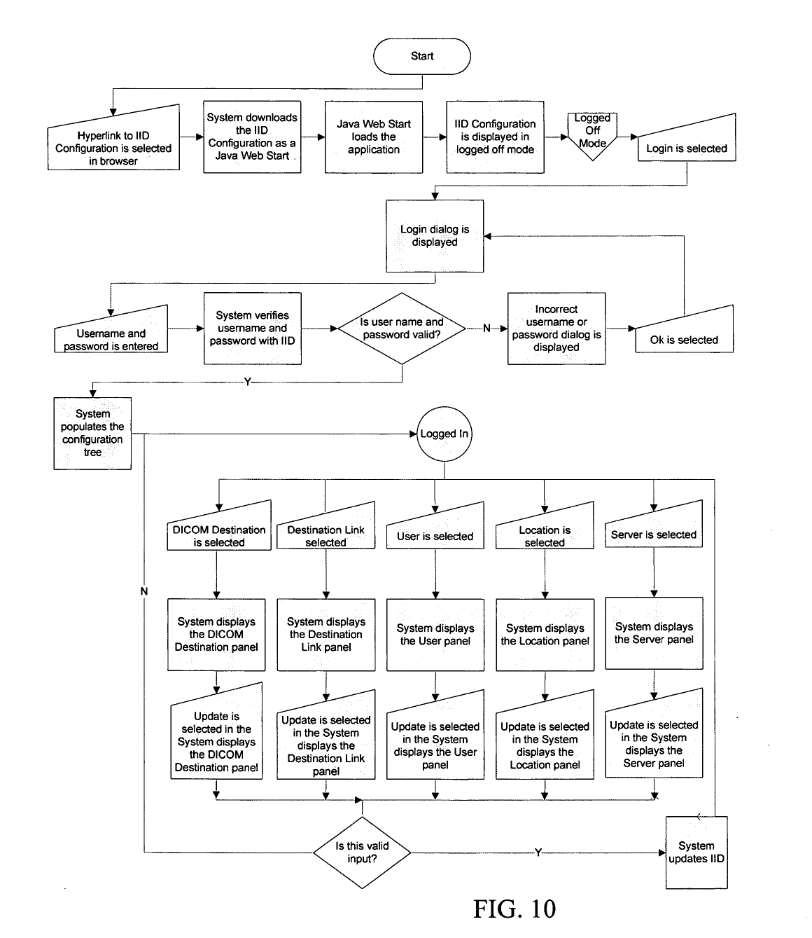

Some embodiments include the IID Configuration tool, which may be a Java Web Start tool which may connect to IID Receive Servers in order to configure them, and global configuration for IID. FIG. 10 depicts a diagram of the IID configuration flow. In some aspects of the invention, the IID Configuration Tool may have one or more features including but not limited to Product overview, Server Monitoring, Log Viewing, Configuration TreeIID Configuration, DICOM Destinations Configuration, Cleanup, DICOM Destination Link Configuration, Location Configuration, User Configuration, and Server Configuration. In the Product Overview feature, the IID Configuration application may connect to IID Receive servers in order to configure destinations and users. In the Server Monitoring feature, the IID Tech may view the status of all IID Servers visually and may be alerted both visually and audibly to potential issues so corrective action can be taken. In the Log Viewing feature, the IID Tech may view current and previous log files for all the IID servers. The log viewer may display log details, log severity, time of the log, and also enable advanced sorting and filtering functionality to enable easy IID administration. In the Configuration TreeIID Configuration feature, a standard configuration type where the different configurations may be organized in a tree. The IID Tech may be expanded the different configuration nodes in order to select objects to edit, create new objects, and delete objects. In the DICOM Destinations Configuration feature, the DICOM destinations may be configured by the IID Tech when a DICOM Destination may be selected in the Configuration Tree. When the DICOM Destination may be selected a panel may display the description, hostname, AE Title, Destination Type, whether the destination may be active or not, if the destination may be set to auto forward, and if it is enabled—which may all be configured and updated. In the Cleanup feature, the IID Tech may clean up IID by location. In the DICOM Destination Link Configuration feature, DICOM destination links may be configured by the IID Tech when a DICOM Destination Link may be selected under a DICOM Destination node in the Configuration Tree. When the DICOM Destination Link may be selected a panel may display the description, bandwidth, consistency, maximum number of TCP connections, reliability, IP address, and port—which may all be configured and updated. In the Location Configuration feature, locations may be configured by the IID Tech when a Location may be selected in the Configuration Tree. When the Location may be selected a panel may display the location name and description—which may both be configured and updated. In the User Configuration feature, users may be configured by the IID Tech when a User may be selected in the Configuration Tree. When the User may be selected a panel may displays user name, display name, full name, password, and location—which may all be configured and updated, though the password may not viewable and may only be set. From this panel the IID Tech may also associate DICOM Destinations to Users so that the DICOM Viewer may be configured to send to the associated DICOM Destination when the username may be selected to send. In the Server Configuration feature, servers may be configured by the IID Tech when a Server may be selected in the Configuration Tree. When the Server may be selected a panel displays the server name, DICOM Viewer may update IP address and port, the RMI IP address and port, location, server type, description, operating system, processor type, number of processors, DICOM disk capacity, image disk capacity, and case style—which may all be configured and updated. From this panel the IID Tech may also ping the server address to test connectivity.

Some embodiments of the invention include IID Tech. IID Tech allows an IID Tech to configure IID through a visual interface from any location. In some aspects of the invention, the IID Tech may have features including but not limited to Layout, Login, Server Monitoring, Log Viewing, Display Configurations, Open DICOM Destination, Open DICOM Destination Link, Open Location, Open User, Open Server, Edit DICOM Destination Type, and Edit DICOM Destination.

In the Layout feature, the layout of the GUI should be intuitive, organized, uncluttered, and simple. All components should have the ability to be resized by the user at runtime. The GUI shall have the format of the following diagrams. In the Login feature, The IID Tech may be required to supply a username and password to log into the viewer. By logging on, the IID Tech's user preferences are loaded, connection to IID Receive Servers may be established, and Studies are downloaded from the IID Receive Servers. In the Server Monitoring feature, The IID Tech can view the status of all IID Servers visually and may be alerted both visually and audibly to potential issues so corrective action can be taken. They can also select a server of interest and be taken to a the corresponding server logs to ascertain the cause of the server alert. In the Log Viewing feature, the IID Tech can view current and previous log files for all the IID servers. When a server may be selected the log viewer displays server information to better identify which server may be selected. The log viewer will display log details, log severity, time of the log, and also enable advanced sorting and filtering functionality to enable easy IID administration. It will also have the capability to view logs for a manually entered IP address in the event that the IID Configuration may be unable to communicate with an IID Receive Server to obtain the server information. In the Display Configurations feature, The IID Tech can view all the configurations in a tree format when they have successfully logged in. In the Open DICOM Destination feature, the IID Tech can open a DICOM Destination by selecting its node from the tree. In the Open DICOM Destination Link feature, the IID Tech can open a DICOM Destination Link by selecting its node from the tree. In the Open Location feature, The IID Tech can open a Location by selecting its node from the tree. In the Open User feature, the IID Tech can open a User by selecting its node from the tree. In the Open Server feature, the IID Tech can open a Server by selecting its node from the tree. In the Edit DICOM Destination Type feature, the DICOM Destination Types can be configured by the IID Tech to change the name or to edit the description. In the Edit DICOM Destination feature, DICOM destinations can be configured by the IID Tech when a DICOM Destination may be selected in the Configuration Tree. When the DICOM Destination may be selected a panel displays the description, hostname, AE Title, Destination Type, whether the destination may be active or not, if the destination may be set to auto forward, and if it may be enabled—which can all be configured and updated.

In some embodiments, IID Tech may edit one or more of the following fields: description, hostname, AE title, port, and user, Edit DICOM Destination Link. DICOM destination links may be configured by the IID Tech when a DICOM Destination Link may be selected under a DICOM Destination node in the Configuration Tree. When the DICOM Destination Link may be selected a panel may display the description, bandwidth, consistency, maximum number of TCP connections, reliability, IP address, and port—which may all be configured and updated. In the Edit Location feature, the Locations may be configured by the IID Tech when a Location may be selected in the Configuration Tree. When the Location may be selected a panel may display the location name and description —which may both be configured and updated. In the Edit User feature, Users may be configured by the IID Tech when a User may be selected in the Configuration Tree. When the User may be selected a panel may display user name, display name, full name, password, and location—which may all be configured and updated, though the password may be not viewable and may only be set. From this panel the IID Tech may also associate DICOM Destinations to Users so that the DICOM Viewer will be configured to send to the associated DICOM Destination when the username may be selected to send. The Associate Users to Servers feature, the IID Tech may associate Users to Servers so that when a QC Assistant selects a User to send to in the DICOM viewer, IID may automatically resolve which Destination(s) to send to. In the Edit Server Type feature, Server Types may be configured by the IID Tech to change the name or to edit the description. In the Edit Server feature, Servers may be configured by the IID Tech when a Server may be selected in the Configuration Tree. When the Server may be selected a panel displays the server name, DICOM Viewer update IP address and port, the RMI IP address and port, location, server type, description, operating system, processor type, number of processors, DICOM disk capacity, image disk capacity, and case style—which may all be configured and updated. From this panel the IID Tech may also ping the server address to test connectivity. In the Ping Server feature, the IID Tech may ping a selected server to obtain connectivity information. In the Edit User feature, the IID Tech may edit the following fields: display. In the Create DICOM Destination Type feature, the IID Tech may create a new DICOM destination type to use in configuring DICOM destinations. In the Create DICOM Destination feature, the IID Tech may create a DICOM destination destination in which a default DICOM destination may be added to the Configuration TreeDICOM Destination Configuration node of the Configuration Tree. In the Create DICOM Destination Link feature, the IID Tech may create a new DICOM destination link in which a default DICOM destination link may be added to the selected DICOM destination. In the Create Location feature, the IID Tech may create a new Location in which a default DICOM destination may be added to the Location Configuration node of the Configuration Tree. In the Create User feature, the IID Tech may create a User where a default User may be added to the User Configuration node of the Configuration Tree. In the Create Server Type feature, the IID Tech may create a Server Type to use in configuring Servers. In the Create Server feature, The Tech may create a Server where a default Server may be added to the Server Configuration node of the Configuration Tree. In the Delete DICOM Destination Type feature, the IID Tech may delete a DICOM Destination Type. In the Delete DICOM Destination feature, the IID Tech may delete a DICOM Destination. In the Delete DICOM Destination Link feature, the IID Tech may delete a DICOM Destination Link. In the Delete Location feature, the IID Tech may delete a Location. In the Delete User feature, the IID Tech may delete a User. In the Delete Server Type feature, the IID Tech may delete a Server Type. In the Delete Server feature, the IID Tech may delete a Server. In the Default Properties feature, the IID Tech will be able to configure the default properties to be used for all new objects. In the Cleanup feature, the IID Tech may be able to perform IID cleanup actions by Location.

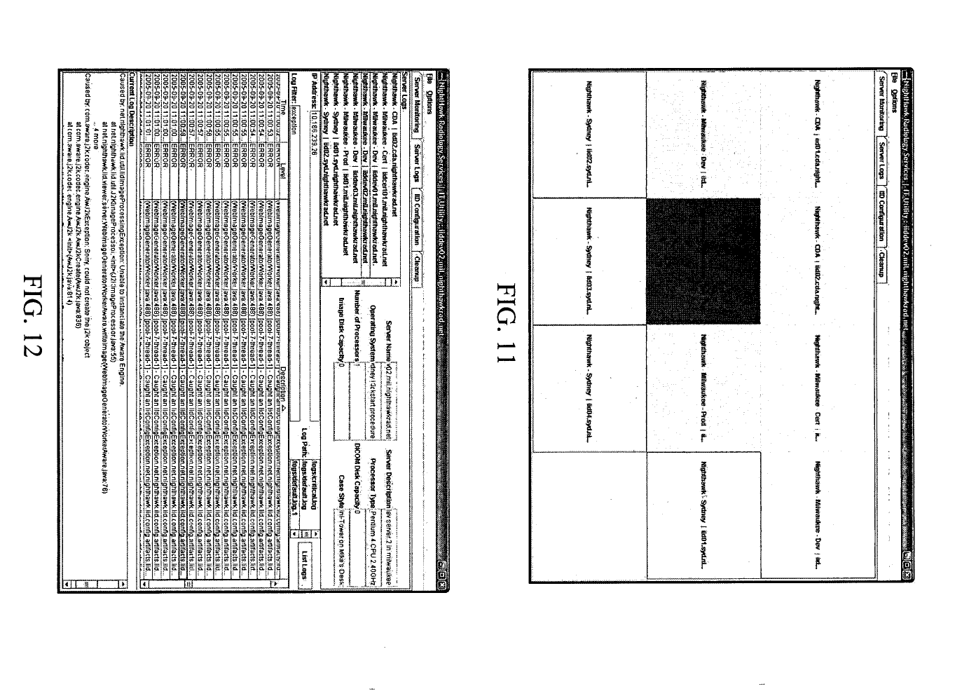

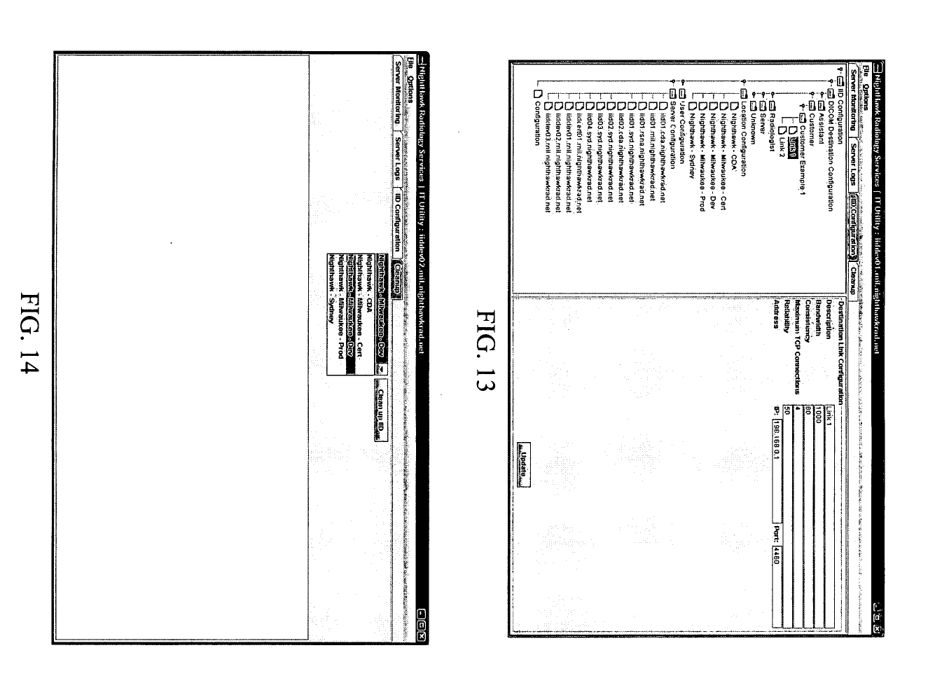

FIG. 10 depicts the server monitor user interface. FIG. 11 depicts the log viewer used interface. FIG. 12 depicts the IID configuration used interface. FIG. 13 depicts the IID cleanup user interface.

### EXAMPLE 1

### Get Destination List

This example describes the flow of events that are required for an IID Viewer to get a current list of Destinations.

Pre-Conditions: IID Viewer is connected to an IID Server

Post-Conditions: IID Viewer has an updated destination list

Basic Flow

1. IID Viewer issues a command to the IID Server to get the Destination list
2. The IID Server receives the command and requests the current Destinations from the IID Server database.
3. The IID Server database returns the list of Destinations to the IID Server.
4. The IID Server processes the list, and sends the list to the IID Viewer.

### EXAMPLE 2

### Get Study List

This example describes the process followed when an IID Server populates the study list that resides in an IID Viewer.
   Pre-Conditions: IID Viewer has an update connection to the IID Server; IID Server has a connection to the IID Server database; IID Server database contains a study list; IID Server knows the last time it sent an update.
   Post-Conditions: IID Viewer has a current Study List.
   Basic Flow
1. The IID Server queries the IID Server database for all studies that belong in the study list.
2. The IID Server database returns a list the current studies to the IID Server.
3. The IID Server properly formats the study list, and sends the list to the IID Viewer via the update connection.
4. The IID Server returns the sends the study list to the IID Viewer.
   Alternative Flows
1. The IID Server determines the study list needs to be updated.
2. The IID Server queries the IID Server database for all studies that have been updated
3. The IID Server database returns a list of updated studies to the IID Server.
4. Normal flow resumes at step 3

### EXAMPLE 3

### Load Balance Incoming Transfer

This example describes how incoming transfers are load balanced between individual IID Receive Servers.
   Pre-Conditions: The Load Balancing Machine has a list of IID Receive Servers to balance connections among. The IID Receive Servers are all setup to receive connections, on the same address and port.
   Post-Conditions: The Load Balancing Machine can update its list of IID Receive Servers.
   Basic Flow
1. DICOM Peer attempts to form a connection with the IID Receive server.
2. The Load Balancing Machine accepts the connection from the DICOM Peer on behalf of the IID Receive Server
3. The Load Balancing Machine chooses the next available IID Receive Server.
4. The Load Balancing Machine forms a connection to the IID Receive Server of choice.
5. The Load Balancing Machine transparently forwards all data between the two connections.
   Alternative Flows
   IID Receive Server does not respond
This alternative flow begins at step 4, when the Load Balancing Machine cannot form a connection to the IID Receive Server.
   1. The Load Balancing Machine cannot form a connection to the IID Receive Server of choice.
   2. The Load Balancing Machine takes note of the failed connection.
   3. Normal flow is resumed at step 3.
No IID servers to choose from
This alternative flow begins at step 3, when the Load Balancing Machine has no IID Receive Servers to connect to.
   1. The Load Balancing Machine cannot choose an IID Receive Server.
   2. The Load Balancing Machine records the error.
   3. The example ends without a connection being formed.

### EXAMPLE 4

### Receive DICOM Study

This example describes the process of receiving a data transmission. IID will primarily be responsible for transferring DICOM studies with a DICOM 3.0 compliant peer so this example will describe the flow of a DICOM study. Any other data transmission will follow a similar process.
   Post-Conditions: The DICOM study now resides on the IID server. The DICOM study information now resides in the IID server database.
   Basic Flow
1. The DICOM Peer opens a DICOM association with the IID server.
2. The DICOM Peer presents a list of transfer syntaxes the data can be transferred in.
3. The IID server responds with a list of preferred transfer syntaxes.
4. The DICOM Peer sends a DICOM study using an agreed upon transfer syntax.
5. The IID server receives the DICOM study.
6. The DICOM Peer closes the DICOM association.
7. The IID server processes the DICOM study, and notifies the IID server database with data about the DICOM study, along with storing the DICOM study in the data store.
   Alternative Flows
DICOM Transfer syntax not supported.
This alternative flow begins at step 3, when the IID server does not support any of the transfer syntaxes the DICOM Peer lists.
   1. The IID server cannot receive a particular transfer syntax.
   2. The IID server aborts the association, giving the appropriate reason to the DICOM Peer.
   3. The example ends without a DICOM study being transferred.
DICOM Study already exists on IID server
This alternative flow begins at step 7, when the IID server determines the Study being received already exists.
   1. The IID server inspects the study that is being received, and determines that it already exists in the system.
   2. The IID server queries the IID server database for all information about the DICOM study.
   3. The IID server database returns all known information about the study.
   4. The IID server appropriately appends any new information to the study, and replaces any updated information with the incoming study.
   5. The example ends successfully.
DICOM study already exists in IID server database.
This alternative flow begins at step 7 when the IID server determines the Study being received already exists in the IID server database. This usually means the study already exists on a different IID server.
   1. The IID server inspects the study being received, and determines that it already exists in the IID server database.
   2. The IID server queries the IID server database for all information about the DICOM study.
   3. The IID server notifies the IID server database with the information on the DICOM study, and stores the DICOM study on the data store.
   4. The IID server sends the study to the IID server that the rest of the study resides on.
   5. The example ends successfully.

### EXAMPLE 5

### Save DICOM Study

IID will primarily be responsible for handling DICOM studies, so this example will describe the flow of a DICOM study. Other types of data will be handled in a similar fashion.
This example describes the flow of events that are necessary to save changes to information within a DICOM study.
   Pre-Conditions: Study must exist; IID Viewer must be connected to the IID Server; IID Viewer must have updated information for the IID Server; IID Viewer must have study locked
   Post-Conditions: DICOM study is saved with updated information
   Basic Flow
1. IID Viewer issues a command, with updated data, to the IID Server to save the updated data to the DICOM Study files, and the IID Server database.
2. The IID Server validates the updated data.
3. The IID Server loads the original study data from disk, and applies the updates.
4. The IID Server saves the updated study data to the disk.
5. The IID Server submits the updated study data to the IID Server database.
6. The IID Server database updates the required study information, and returns a successful result.
7. The IID Server returns a successful result to the IID Viewer.

### EXAMPLE 6

### Send DICOM Study

This example describes the process of sending a Data Transmission to a Destination. IID will primarily be responsible for transferring DICOM studies with a DICOM 3.0 compliant peer so this example will describe the flow of a DICOM study. All IID Servers are capable of sending a DICOM study to a DICOM peer.
   Pre-Conditions
The IID Server should have the DICOM study to be sent.
The IID Server database should have information about the DICOM study to be sent.
The DICOM Peer should have association information stored within the IID Server database.
   Post-Conditions
The IID server has record of the transmission.
   Basic Flow
1. The IID Server receives a command to send a DICOM study to a known DICOM Peer.
2. The IID Server requests the DICOM Peer information from the IID Server database.
3. The IID Server database returns the primary information for the DICOM Peer.
4. The IID Server requests the study information from the IID server database.
5. The IID server database returns all relevant study info to the IID server.
6. The IID Server retrieves the image data from the image data store.
7. The IID Server forms a DICOM association with the DICOM Peer.
8. The IID Server requests available transfer syntaxes from the DICOM Peer.
9. The DICOM Peer returns appropriate transfer syntaxes.
10. The IID Server sends the DICOM study using the transfer syntax the files are in already.
11. The IID Server releases the association with the DICOM Peer.
   Alternative Flows
DICOM Peer does not respond.
This alternative flow begins when step 7 of the basic flow fails.
   1. The IID server requests alternative DICOM Peer information from the IID server database.
   2. The IID server database returns alternative DICOM Peer information to the IID server.
   3. The IID server forms a DICOM association with the DICOM Peer using the alternative information.
   4. Basic flow resumes at step 8.
DICOM Peer does not respond at all.
This alternative sub-flow begins when all methods of connecting to the DICOM Peer have failed.
   1. The IID server cannot form a DICOM association with the DICOM Peer.
   2. The IID server notifies the IID server database of the failed attempt at a connection.
   3. The example ends without a study being transmitted.
DICOM Study does not exist in the database.
This alternative flow begins at step 5, when the DICOM Study cannot be found in the database.
   1. The IID server database returns a negative result to the IID server.
   2. The IID server notifies the IID server database of the failed attempt at a send.
   3. The example ends without a study being transmitted.
DICOM Study does not exist in data store
This alternative flow begins at step 6, when the DICOM Study cannot be found on the data store.
   1. The IID server cannot locate the DICOM Study on the data store.
   2. The IID server notifies the IID server database of the failed attempt at a send.
   3. The example ends without a study being transmitted.
DICOM file is not already in a supported transfer syntax
This alternative flow begins at step 10, when the list of transfer syntaxes returned by the DICOM Peer does not contain the current transfer syntax of the DICOM Study.
   1. The IID server determines the DICOM Study is in a different format than the DICOM Peer can receive.
   2. The IID server converts the DICOM Study to a supported transfer syntax.
   3. Basic flow resumes at step 10.
DICOM Peer Transfer syntax not supported by IID
This alternative flow begins at step 9, when the IID server determines there is no transfer syntax overlap between itself and the DICOM Peer.
   1. The IID server cannot find any compatible transfer syntaxes between itself and the DICOM Peer.
   2. The IID server aborts the DICOM association, giving the appropriate reason to the DICOM Peer.
   3. The IID server notifies the IID server database of the failed transfer.
   4. The example ends without a study being transmitted.

### EXAMPLE 7

### Connect to IID Receive Servers

The IID Viewer is a client to the IID Server, and so it must connect to an IID Server in such a manner.
The connection provides ability to receive and issue commands from client to server.
   Pre-Conditions
System has a working network connection.
   Post-Conditions
System is connected to an IID Receive Server.
   Basic Flow
1. System queries a list of IID Receive Servers to connect to.
2. System picks a server fro the list to connect to at random.
3. System connects to IID Receive Server through DNS lookup.
4. System establishes a connection to the IID Receive Server.
   Alternative Flows
Unable to Connect to an IID Receive Server
Network connection is unavailable.
   1a. QC Tech Assistant alerts an IT contact to resolve the problem or resolves the problem themselves.
System fails to connect to IID Receive Server
1. Error is logged

### EXAMPLE 8

### Filter Studies

Filtering Studies is done is the Studies Worklist. A filter box is provided for every column in the Studies Worklist so that multiple filters can be applied at once.
   Pre-Conditions
System has received Studies to be displayed.
   Post-Conditions
The Studies Worklist displays only Studies that include the filter keywords QC Tech Assistant has entered.
   Basic Flow
1. QC Tech Assistant enters a filter for a column in the table of Studies.
2. System filters all Studies in the table based upon that value.

### EXAMPLE 9

### Flip

Flip provides the ability to flip an image 180 degrees.
   Pre-Conditions
A Study Slice Image that is being displayed.
   Post-Conditions
The image has been flipped 180 degrees.
   Basic Flow
1. QC Tech Assistant selects flip from the image menu, or image toolbar.
2. System flips the current Study Slice Image.

### EXAMPLE 10

### Load Destinations

Destinations are loaded from an IID Receive Server and placed are designated as the current Destinations. Loading Destinations occurs when the QC Tech Assistant logs on and periodically as the application runs. These Destinations are selectable by the QC Tech Assistant, and used when a Study is to be sent.
   Pre-Conditions
Destinations have been properly set up in the IID Configuration.
Server from the IID Viewer has been established.
QC Tech Assistant has logged on.
   Post-Conditions
System has added all the current Destinations.
   Basic Flow
1. System asks IID Receive Server for a list of Destinations.
2. System adds every Destination to current Destinations.
   Alternative Flows
System fails to connect to IID Receive Server
1a. Error is logged

### EXAMPLE 11

### Load Studies

Studies are loaded from an IID Receive Server and placed in the Studies Worklist. Loading Studies occurs when the QC Tech Assistant logs on and periodically Studies are pushed out to the Viewer from IID Receive Servers as they are received.
   Pre-Conditions
QC Tech Assistant has logged on.
   Post-Conditions
All available Studies have been added to the Studies Worklist.
   Basic Flow
1. System gets Studies from IID Receive Server.
2. System adds every Study loaded to the Studies Worklist.
   Alternative Flows
System fails to connect to IID Receive Server
1. Error is logged

### EXAMPLE 12

### Load Study Images

Loading Study images is done upon opening a Study from the Studies Worklist. The Slice images are pulled from the IID Receive Servers.
   Pre-Conditions
System is connected to an IID Receive Server
   Post-Conditions
System displays all Slice Image thumbnails of the Study
   Basic Flow
1. System gets all Slice Image locations from the Study.
2. System loads all Slice Images asynchronously.
3. System displays Slice Images as thumbnails as they are loaded.
4. System displays the first Slice Image.
   Alternative Flows
System fails to connect to IID Receive Server
1. Error is logged
Study Slice Image fails to load properly
1. Blank image thumbnail is displayed.
2. Error is logged.

### EXAMPLE 13

### Login

The QC Tech Assistant is required to supply a username and password to log into the viewer. By logging on, the QC Tech Assistant's user preferences are loaded, connection to IID Receive Servers is established, and Studies are downloaded from the IID Servers.
   Pre-Conditions
The QC Tech Assistant has opened the IID DICOM Viewer application.
   Post-Conditions
The QC Tech Assistant's user preferences are loaded, connection to IID Receive Servers is established, and Studies are downloaded from the IID Servers.
   Basic Flow
1. QC Tech Assistant runs the IID DICOM Viewer application.
2. System displays login dialog.
3. QC Tech Assistant enters username and password.
4. System asks an IID Receive Server to verify the username and password.
5. System connects to IID Receive Servers: Include Connect to IID Receive Servers.
6. IID Receive Server verifies the login.
7. IID Receive Server sends the QC Tech Assistant's user preferences.
8. System loads the QC Tech Assistant's user preferences: Include Set User Location.
9. System closes the login dialog and starts the IID DICOM Viewer.
   Alternative Flows
DICOM Viewer Fails to Load
1a. Required libraries are not installed correctly.
   1. QC Tech Assist alerts an IT contact to resolve the problem.
   2. System logs the error.
1b. Network connection is unavailable.
   1. QC Tech Assist alerts an IT contact to resolve the problem or resolves the problem themselves.
Incorrect User Name/Password
6a. System returns to 2.

### EXAMPLE 14

### Move/Set Visible Study Columns

Columns in the Studies Worklist can be moved by dragging the column with the mouse and can be set visible through a configuration dialog.
   Pre-Conditions
The Studies Worklist has been loaded with Studies
   Post-Conditions
The Studies Worklist contains the columns selected by the QC Tech Assistant.
   Basic Flow
1. QC Tech Assistant opens tools->options->configuration.
2. QC Tech Assistant selects which columns should be visible in the Studies Worklist.
3. QC Tech Assistant selects OK.
4. System applies the configuration changes.
5. System closes the configuration dialog.

### EXAMPLE 15

### Open Study

Opening a Study is done through the Studies Worklist. A double click or space key on a study in the table will result in the Study being opened. When a Study is open, its thumbnails, slice image, and study details are displayed. This is also the only way a Study can have its detail information changed and updated.
   Pre-Conditions
The Studies Worklist has been loaded with Studies
   Post-Conditions
The System has loaded the Study Images, the Study thumbnails are displayed, the first Study Slice Image is displayed, and the Study Detail is displayed.
   Basic Flow
1. QC Tech Assistant double clicks on a Study in the table of Studies.
2. System loads the study images.
3. System displays the study's thumbnail images.
4. System displays the first study slice image.
5. System displays the study detail.
   Alternative Flows
Incorrect Study is loaded
QC Tech Assistant logs the error.

### EXAMPLE 16

### Rotate

Rotate provides the ability to rotate an image 90 degrees.
   Pre-Conditions
The Studies Worklist has been loaded with Studies, and a Study has been opened.
   Post-Conditions
The Study Slice Image has been rotated and is displayed at its new rotation angle in the IID Viewer.
   Basic Flow
1. QC Tech Assistant selects rotate from the image menu.
2. System rotates the current Study Slice Image.
3. System sets the rotation angle of the Slice.

### EXAMPLE 17

### Select Destination

A list of destinations is provided for sending studies.
   Pre-Conditions
The QC Tech Assistant has logged on.
   Post-Conditions
A Radiologist Destination has been selected.
   Basic Flow
1. QC Tech Assistant selects a Destination.
2. System highlights the Destination.

### EXAMPLE 18

### Select Slice

Slice selection is for selecting a Slice Image from an open Study and displaying it as the Study Slice Image. Selecting a slice is done by two different methods, selecting the Slice image thumbnail or changing the cine slider position.
   Pre-Conditions
The Studies Worklist has been loaded with Studies, and a Study has been opened.
   Post-Conditions
A Slice has been selected, the current Slice Image has been set and displayed, and the current window level and width have been applied to the Slice Image.
   Basic Flow
1. QC Tech Assistant selects a Slice Image from the Slice Image thumbnails or by changing the cine slider's position.
2. System sets the current Slice Image to the selected Slice Image.
3. System scales the Slice Image is scaled to fit in the current view size.
4. System applies the current window level and width to the Slice Image.
   Alternative Flows
Window Levels are Unable to be applied.
4b. QC Tech Assistant logs a bug report.

### EXAMPLE 19

### Select Study

Studies are selected in the Studies Worklist by clicking on the study row. Selected
Studies are only used when Studies are sent to a destination.
   Pre-Conditions
The Studies Worklist has been loaded with Studies.
   Post-Conditions
A Study has been selected, and is highlighted in the Studies Worklist table.
   Basic Flow
1. QC Tech Assistant selects a study in the Studies Worklist table.
2. System highlights the row (Study) in the table.

### EXAMPLE 20

### Send Slices

Send Slices will send the currently selected Study Slices in the Slice Image thumbnail panel to the currently selected destination or user.
   Basic Flow
1. QC Tech Assistant selects Send Slices.
2. System gets the selected Slices from the Study Image thumbnail panel.
3. System gets the selected Radiologist Destination or User.
4. System asks the IID Receive server that has the Slices to send the Slices to the Radiologist Destination.
5. System repeats step 4 for all selected Slices.

### EXAMPLE 21

### Send Study

Send Study will send the currently selected Studies in the Study Browser to the currently selected destination.
   Basic Flow
1. QC Tech Assistant selects send Study.
2. System gets the selected Studies from the Study Browser table.
3. System gets the selected Radiologist Destination.
4. System asks the IID Receive server that has the Study to send the Study to the Radiologist Destination.
5. System repeats step 4 for all selected Studies.
   Alternative Flows
   No Studies are Selected
2a. System ignores the send request.
   No Destination is Selected
3a. System ignores the send request.
   IID Receive Server fails to send the Study
4a. QC Tech Assistant is notified and error is logged.

### EXAMPLE 22

### Set GUI Preferences

GUI preferences can be set through a configuration dialog, can be saved by the QC Tech Assistant or saved automatically upon exit.
   Pre-Conditions
The QC Tech Assistant has logged in.
   Post-Conditions
The QC Tech Assistant's preferences have been updated on the IID Receive Server.
   Basic Flow
1. QC Tech Assistant opens the tools->options dialog.
2. System displays the options dialog.
3. QC Tech Assistant set GUI preferences in the dialog.
4. QC Tech Assistant selects OK.
5. System asks an IID Receive Server to update the QC Tech Assistant's configuration file.
6. IID Receive Server updates the QC Tech Assistant's configuration file.
7. System closes the configuration dialog.
   Alternative Flows
System fails to connect to IID Receive Server
1. Error is logged
IID Receive Sever Fails to Save QC Tech Assistant's Preferences
1. IID Receive serve handles the error.

### EXAMPLE 23

### Set User Location

Setting the QC Tech Assistant location is done upon login to the IID DICOM Viewer, this enables date formatting based upon locale.
   Pre-Conditions
The QC Tech Assistant has logged in.
   Post-Conditions
The QC Tech Assistant location has been set.
   Basic Flow
1. QC Tech Assistant selects tools→options.
2. QC Tech Assistant selects location.
3. QC Tech Assistant selects their location.
4. QC Tech Assistant selects OK.
5. System sets the current location.
6. System sets all formatting (date) to new location.
7. System closes the location dialog.

### EXAMPLE 24

### Set Window Level

Window Widths/Levels are applied to the Study Slice Image. Setting the Window Width and Level is done though three different methods: Right-drag of mouse, manipulation of slider bars for each value, and buttons with preset values for standard window levels and widths. These preset window levels and widths are: Brain, Bone, Liver, Lung, and Angio.
   Pre-Conditions
The QC Tech Assistant has logged in, and a Study has been selected.
   Post-Conditions
The desired window level has been set and applied to the current Slice Image.
   Basic Flow
1. QC Tech Assistant selects a window leveling button, changes the window level slider bar, or right-drags the mouse vertically.
2. System gets the slope value from the current Slice Image.
3. System gets the intercept value from the current Slice Image.
4. System uses the slope and intercept to apply the window level to the image.
5. System displays window level.
   Alternative Flows
Setting window level results in a non-viewable image
4a. QC Tech person logs the error.

### EXAMPLE 25

### Set Window Width

Window Widths/Levels are applied to the Study Slice Image. Setting the Window Width and Level is done through three different methods: right dragging the cursor left or right on the Study Slice Image, manipulation of slider bars for each value, and buttons with preset values for standard window levels and widths. These preset window levels and widths are: Brain, Bone, Liver, Lung, Angio, and Automatic.
   Pre-Conditions
The QC Tech Assistant has logged in, and a Study has been selected.
   Post-Conditions
The desired window width has been set and applied to the current Slice Image, and is displayed in the status bar.
   Basic Flow
1. QC Tech Assistant selects a window leveling button, changes the window width slider bar, or right drags the cursor left or right on the Study Slice Image to set the window width.
2. System gets the slope value from the current Slice Image.
3. System gets the intercept value from the current Slice Image.
4. System uses the slope and intercept to apply the window width to the image.
5. The window width is displayed in the status bar.
   Alternative Flows
Setting window width results in a non-viewable image
4a. QC Tech person logs the error.

### EXAMPLE 26

### Sort Studies

Sorting Studies is done is the Studies Worklist. This is done by standard table sorting, clicking on the table column headers to specify sorting order.
   Pre-Conditions
The QC Tech Assistant has logged in and the Studies Worklist has been loaded.
   Post-Conditions
The Studies Worklist has been sorted by the selected column.
   Basic Flow
1. QC Tech Assistant selects a column header in the table of Studies.
2. System sorts studies in table according to column values' types.
3. System maintains selection row.

### EXAMPLE 27

### Toggle Ignored

Toggling whether a Study is ignored is done through the Studies Worklist. A right click on a study in the table will bring up a menu. The user can then select either “Ignore” or “Unignore” and the Study status will be changed appropriately.
   Pre-Conditions
The Studies Worklist has been loaded with Studies
   Post-Conditions
The Study's status has been changed to Ignored or Unignored.
   Basic Flow
1. QC Tech Assistant selects Ignore or Unignore from the right click menu of the Studies Worklist.
2. System changes the Study status.
3. System displays the Study's new status.
   Alternative Flows
QC Tech Assistant right clicks but selects something besides Ignored or Unignored.

### EXAMPLE 28

### Translate

Translate provides the ability to translate an image.
   Pre-Conditions
The QC Tech Assistant has logged in, and a Study has been opened.
   Post-Conditions
The Study Slice Image is displayed translated by the amount and direction that the QC Tech Assistant has dragged it.
   Basic Flow
1. QC Tech Assistant drags the Study Slice Image by left clicking on the image.
2. System translates the Study Slice Image appropriately.

### EXAMPLE 29

### Translate

Translate provides the ability to translate an image.
   Pre-Conditions
The QC Tech Assistant has logged in, and a Study has been opened.
   Post-Conditions
The Study Slice Image is displayed translated by the amount and direction that the QC Tech Assistant has dragged it.
   Basic Flow
1. QC Tech Assistant drags the Study Slice Image by left clicking on the image.
2. System translates the Study Slice Image appropriately.

### EXAMPLE 30

### Update Study

A Study can be updated (back to the originating IID Receive Server) when its data has been changed.
   Pre-Conditions
The QC Tech Assistant has logged in and edited study details.
   Post-Conditions
The IID Receive Server has updated the Study.
   Basic Flow
1. QC Tech Assistant selects update.
2. System sets the data in the Study Detail to the Study.
3. System asks the IID Receive Server to update the Study with the new data.
4. IID Receive Server updates the Study.
   Alternative Flows
No Study is Open
1a. System ignores the update.
IID Receive Server Fails to Update the Study
4a. QC Tech Assistant is notified and error is logged.

### EXAMPLE 31

### View Study DICOM Information

Viewing a Study's DICOM Information is done from the Studies Worklist. When a Study is selected, a user can select the View Study Information hotkey. A window will pop up displaying the Study DICOM information.
   Pre-Conditions
The Studies Worklist has been loaded with Studies
   Post-Conditions
The Study DICOM information window is displayed.
   Basic Flow
1. QC Tech Assistant selects a Study from the Studies Worklist.
2. QC Tech Assistant presses the View Study Information hotkey.
3. System displays the Study DICOM information window.
   Alternative Flows
QC Tech Assistant presses the View Study Information hotkey but no Study is selected in the Studies Worklist.

### EXAMPLE 32

### View Study History

Viewing a Study's history is done from the Studies Worklist. A right click on a study in the table will bring up a menu. The user can then select Study status history and a window will pop up displaying the Study history sorted by time.
   Pre-Conditions
The Studies Worklist has been loaded with Studies
   Post-Conditions
The Study status history window is displayed.
   Basic Flow
1. QC Tech Assistant selects Study status history from the right click menu of the Studies Worklist.
2. System displays the Study status history window.
   Alternative Flows
QC Tech Assistant right clicks but selects something besides Study status history.

### EXAMPLE 33

### Zoom

Zoom provides the ability to flip an image.
   Pre-Conditions
The QC Tech Assistant has logged in, and a Study has been selected.
   Post-Conditions
The Study Slice Image is displayed zoomed by the percentage that the QC Tech Assistant has selected.
   Basic Flow
1. QC Tech Assistant selects zoom from the image menu.
2. System zooms the current Study Slice Image at the next zoom level.
   Configuration Module

Another embodiment includes the configuration module, which is a dynamic module that every IID Server instance contains, yet slightly different for each type of IID Server. Several files will be used to store information for the IID Server, and the information, for example, may be stored in XML format. A database may also be used to store running configuration settings during normal operation, and may provide fast and efficient method for changing running parameters. Any changes in the database may be persisted to the XML files. For example, in case of database connection failure, the configuration module will have its XML file to fall back on, with minimal disruption of service.

In another embodiment, a non-database, configuration file may be stored on a disk, in a secure location. This file will determine the startup parameters, including, but not limited to, IP address, Port, AE_TITLE, IID Receive servers, database connection information, and other configuration file details. To access data in the configuration module, a simple table lookup may be used. Another module queries the configuration module by providing the key of the requested value, and the current value may be returned.

The peer module (the peer module is discussed in detail below) may be responsible for keeping the configuration module synchronized with other configuration modules. Any changes to the data stored within may be submitted to the peer module that resides on the server.

Route Module

Another embodiment of the present invention includes the route module. The route module may be used to control the routing of studies from one place to another. When an association is formed within the association module, the route module is notified, and the appropriate action is taken. The route module bases its decisions on a route table that may be stored in the configuration module. When the appropriate method of sending is located in the route table, a new association may be created using the parameters provided, and may be given the study to be sent. The route module may also interact with the configuration module, notifying it to send data or notify it of received data.

In a specific embodiment, the route module relies on the configuration module to determine which destinations are active or inactive. If a destination is found to be in a different state than the configuration module specifies, the route module updates the configuration module with this new status.

After the study has been accepted for transmission, the route module may determine the method of transfer based on the association when it is formed. The method of transfer may, for example, be via DICOM or a HawkNet push or pull.

In a further embodiment, the route module may also inform a peer module of source information changes. The route module also accepts destination information changes and applies those changes to related transfers.

Some embodiments of the invention may contain an IID Status Monitor whose purpose may be to provide a GUI that will display statistics of IID receive servers. A connection to all IID servers may be established in order to gather statistics. The information that the IID Status Monitor may be displayed in graphical form such as: sending associations, receiving associations, connections, logins, transfer speeds, and logs. In some embodiments, the IID Status Monitor may contain one or more of the following features. In the Logon feature, the IID Tech may be required to supply a username and password to log into the viewer. By logging on, the IID Tech's user preferences may be loaded, connection to IID Receive Servers may be established, and Studies and faxes may be downloaded from IID Receive Servers. In the View Current Sending Associations feature, for each IID Receive server, the IID Tech may be able to view all the current sending associations. In the View Current Receiving Associations feature, for each IID Receive server, the IID Tech may be able to view all the current receiving associations. In the View Logged on Users feature, for each IID Receive server, the IID Tech may be able to view all the logged on users. In the View Average Link Transfer Speeds feature, for each IID Receive server, the IID Tech may be able to view all the average link speeds for each logged on user. In the View Current Link Transfer Speeds feature, for each IID Receive server, the IID Tech may be able to view all the current link speeds for each logged on user. In the View Transfer Logs feature, for each IID Receive server, the IID Tech may be able to view logs for all sent and received associations. In the View Error Logs feature, for each IID Receive server, the IID Tech may be able to view error logs.

Status Module

Another embodiment of the present invention includes the status module, which may be used to store, communicate, and report the status of the entire IID Network. Status information may be stored and logged locally on each server, and may also be reported back to the IID receive servers, and processed there.

In another embodiment, the status module exists as much for monitoring of the system, as it does to report current operating conditions to other modules in the system.

The route module, for example, may report on, among others, destination information, current send queue size, current send queue status, current link status, current link speed, current link latency, study information, transfer information, intended destination, amount transferred, success level, conversion/compression information, amount converted, success level, IID server information, server status, server load level, and server transfer rates. The status module may also maintain a certain level of flexibility; new objects may be added or removed on the fly. Because information and statistics about the object may be vital to the rest of the IID system, new objects can be added to the current object list, and update the statistics accordingly.

Peer Module

Another embodiment includes a peer module. Each peer module may reside on an IID receive server. There are essentially two exemplary types of peer modules: internal and external peer modules. The internal peer module exist on receive servers in the same local subnet and use only the logic necessary to synchronize to other peer modules on that same subnet. The external peer module contains not only the logic needed to synchronize changes to local peer modules, but the ability to synchronize with one or more peer modules that exist on external subnets as well. One of the peer module's responsibilities, for example, may be to maintain connections with other peer modules (Local or External) in other servers. The peer module may also ensure that all module data, among all servers, may be synchronized among all known local and external peer modules.

In the case that an external peer module becomes unable to maintain its connection to its remote peer module on another subnet, in other words it “crashes,” an algorithm shall be called within the “next” local peer module which updates itself to become the new external peer module. For example, a peer module can know if it is the “next” peer module when applying initialization settings read from the configuration module. A peer module may communicate directly with the configuration module to determine its list of known local and external peer modules to synchronize with, as well as to store synchronization changes received from other local or external peer modules. A peer module may also poll a status module at given intervals (as specified in the configuration module at initialization) for status changes. In the event of a status change, the peer module may, for example, tell the configuration module to save those status changes to the data store as well as synchronize those status changes to its list of known local and external peer modules.

In another embodiment, the peer module handles all synchronization process standards including new data and changed data from all other modules in the system through notification via the configuration module. All modules that change, for example, need to only tell the configuration module to store those changes in the data store. The configuration module may then notify the peer module of those stored changes and the peer module subsequently synchronize those changes to its list of local and external peer modules.

In a specific embodiment, the peer module synchronizes everything except actual data files. This includes (but is not limited to) the following: system-wide image metadata, system-wide study information, system-wide configuration information, study source information, and destination information.

In another embodiment, certain types of data have a higher priority of synchronization than others. For example, study synchronization has a very high synchronization priority because it may be very important to the system. In a case where study synchronization is needed at the same time as something with a lower synchronization priority, for example, study synchronization shall occur first because it has a higher priority.

An advantage of peer module synchronization is that synchronizing aids in the use of “intelligent image modules”—only data that needs to be sent may be sent. If for some reason it can not be sent, the system resynchronizes and the send may succeed. Synchronization also aids in the efficient use of the “lazy load” data transfer process. That is, if images of a study happen to exist on many different servers, and a command is issued to send the study to a particular destination, sub-commands are issued to the IID servers involved, and each server then sends its portion of the study to the correct destination.

Child Module

Another embodiment of the present invention includes the child module. The child module may reside on a proxy and/or cache servers. It may be a subset of the peer module. It may provide all the same functionality of a peer module, but does not have the logic to synchronize itself among many peers. It connects to a parent peer server only, and synchronizes itself with that server alone. If the connection fails, it may fall over to an alternate peer server connection.

Study Module

Another embodiment of the present invention includes the study module, which may be where all image processing and conversion takes place. Studies may be received in from an association module, and then submitted to the study module. The study module extracts important metadata from the study, and submits it to the peer module. Study data may be inspected, and the studies images may be converted into a standard format specified in the configuration module. Once the initial receive and conversion is complete, the study may then be sent to a background process for conversion to a web-compatible format.

When studies are created in the study module, they may contain default/empty data, or preexisting study images. These study images, for example, are preferably standard images like: JPEG, BMP, Wavelet, GIF, TIFF, etc. Studies can also be combined by simply adding images to a study, or even by adding another studies' set of images to another study. Much like adding images to studies, for example, images can be removed in the same manner. Individual images can be removed from a study and a set of images can be removed from the study.

A study's set of images may be retrieved either locally or remotely, or both locally and remotely. Retrieving images locally, for example, may be performed by simply finding the image on the local file system and loading it into system memory. Retrieving an image set from a remote location may be done through a server controller.

Image format conversion (of a study's images) may be required, for example, in order to communicate with non-IID systems and to supply a viewing application with standard image formats. Also, for an IID viewing application, the image sets may be converted to scaled instances of a standard format, such as web compatible format. When the state of the image conversion is changing, the study module may update the status module.

Intelligence Module

Another embodiment includes the intelligence module. The intelligence module determines the most probable destinations for a received study. The decision may be based on static information stored in the configuration module, and dynamic information stored internally and in the status module. This static information may include, for example: available destinations, number of links, bandwidth, latency, read speed, consistency, reliability, type, and the destination probability threshold. The dynamic information may include, for example: number of concurrent transfers, current utilized bandwidth, current observed latency, current read speed, current queue status, RIS work-list queue status, RIS work-list queue size, destination arbitrary weight factor, destination load factor, projected queue sizes, projected queue status, and projected system load.

In a further embodiment, various weights may be assigned to individual static and dynamic information. Other information that may be used to determine destination probability may include, for example: queue status, current queue status, queue size, current queue size, load factor, and current read speed. The probability calculation uses the most current information available.

In another embodiment of the present invention, when a study is received, the intelligence module may be notified. Upon notification, the probabilities of all destinations are determined, and ordered according to how favorable each destination is. Because the goal of the intelligence module is to intelligently decide where the study may next be needed, the destination probability threshold may be used to choose the most appropriate destinations to send the study to. Send commands with the details of the study and probable destinations may be issued to the route module.

The intelligence module exists, for example, to enhance the probability that a study may be sent to a server as close to the final destination as possible while not interrupting the flow of images from the peer server to the destination after a decision has been made. If the route module informs the intelligence module that a mis-prediction has been made, (a study needed to be sent to a destination that wasn't a probable destination), the intelligence module may adjust the dynamic information appropriately to form better future predictions.

The intelligence module may be in constant communication with the status module and may also update the dynamic information. The projected information may be stored in the intelligence module, along with the most recently known values for the status module. This allows the IID server to continue to function in the event of a partial system failure.

In yet another embodiment, the intelligence module listens for changes to the dynamic information and appropriately issues commands based on this data.

Important changes may include queue status changes, destination changes, and destination availability. The queue status may be changed to disable. For example, commands may be issued to the route module to halt any current sends, and to remove any future sends. Any studies that are canceled may then be submitted back to the intelligence module as a freshly received study. The queue status may be changed to pause. For example, commands may be issued to the route module to remove any future sends, leaving any current sends to finish. Any sends that are canceled may be then submitted back to the intelligence module as a freshly received study. Destination changes may occur when a study was sent to an incorrect destination. The destination availability may change if it is no longer reachable. For example, the route module may be informed that the destination may no longer reachable, and the procedure followed may be the same as a disable queue. The destination availability may also change to available. For example, the new destination may be updated and available in the destination list.

In a further embodiment, the probability calculations use the most recent data in the system; new studies may always be up to date with changes in the system.

### EXAMPLE 34

### Connect to IID Receive Servers

This example describes the process of connecting to IID Receive Servers.

Pre-Conditions

The QC Tech Assistant has logged in.
   Post-Conditions
System is connected to all IID Receive Servers.
   Basic Flow
1. System connects to IID Receive Server through DNS lookup.
2. System retrieves list of IID Receive Servers.
3. System connects to all IID Receive Servers.
   Alternative Flows
Unable to Connect to an IID Receive Server
Network connection is unavailable.
   1a. QC Tech Assist alerts an IT contact to resolve the problem or resolves the problem themselves.
System fails to connect to IID Receive Server
1. Error is logged

### EXAMPLE 35

### Login

The IID Tech is required to supply a username and password to log into the viewer. By logging on connection to IID Receive Servers is established.
   Pre-Conditions
The IID Tech has had a username and password created.
   Post-Conditions
The IID Tech is logged in.
   Basic Flow
1. IID Tech runs the DICOM Viewer application.
2. System displays login dialog.
3. IID Tech enters username and password.
4. System asks an IID Receive Server to verify the username and password.
5. System connects to IID Receive Servers: Include Connect to IID Receive Servers.
6. IID Receive Server verifies the login.
7. System closes the login dialog and starts the IID Status Monitor.
   Alternative Flows
DICOM Viewer Fails to Load
1a. Required libraries are not installed correctly.
   1. IID Tech installs the required libraries to resolve the problem.
   2. System logs the error.
1b. Network connection is unavailable.
   1. IID Tech alerts an IT contact to resolve the problem or resolves the problem themselves.
Incorrect User Name/Password
6a. System returns to 2.

### EXAMPLE 36

### View Current Receiving Associations

For each IID Receive server, the IID Tech should be able to view all the current receiving associations.
   Pre-Conditions
The IID Tech has logged in.
   Post-Conditions
The current receiving association table is displayed.
   Basic Flow
1. IID Tech selects an IID Receive Server.
2. IID Tech clicks the view current receiving associations button.
3. Current receiving association table is displayed.

### EXAMPLE 37

### View Current Sending Associations

For each IID Receive server, the IID Tech should be able to view all the current sending associations.
   Pre-Conditions
The IID Tech has logged in.
   Post-Conditions
The current sending association table is displayed.
   Basic Flow
1. IID Tech selects an IID Receive Server.
2. IID Tech clicks the view current sending associations button.
3. Current sending association table is displayed.

### EXAMPLE 38

### View Error Logs

For each IID Receive server, the IID Tech should be able to view error logs.
   Pre-Conditions
The IID Tech has logged in.
   Post-Conditions
The current receiving error logs are displayed.
   Basic Flow
1. IID Tech selects an IID Receive Server.
2. IID Tech clicks the view error logs button.
3. Error log table is displayed is displayed.
   Alternative Flows
Requirements
The system meets the following requirement:
View Error Logs

### EXAMPLE 39

### View Logged on Users

For each IID Receive server, the IID Tech should be able to view all the logged on users.
   Pre-Conditions
The IID Tech has logged in.
   Post-Conditions
The currently logged on users are displayed for the selected IID Receive Server.
   Basic Flow
1. IID Tech selects an IID Receive Server.
2. IID Tech clicks the view logged on users table button.
3. Logged on users table is displayed.

### EXAMPLE 40

### View Transfer Logs

For each IID Receive server, the IID Tech should be able to view logs for all sent and received associations.
   Pre-Conditions
The IID Tech has logged in.
   Post-Conditions
The transfer log table is displayed for the selected IID Receive Server.
   Basic Flow
1. IID Tech selects an IID Receive Server.
2. IID Tech clicks the view transfer logs button.
3. System displays transfer log table.
   Alternative Flows
Requirements
The system meets the following requirement:
View Transfer Logs

### EXAMPLE 41

### Connect to IID Receive Servers

This example describes the process of connecting to IID Receive Servers.
   Pre-Conditions
System has a working network connection.
   Post-Conditions
System is connected to all IID Receive Servers.
   Basic Flow
1. System connects to IID Receive Server through DNS lookup.
2. System retrieves list of IID Receive Servers.
3. System connects to all IID Receive Servers.
   Alternative Flows
Unable to Connect to an IID Receive Server
   Network connection is unavailable.
      1a. QC Tech Assist alerts an IT contact to resolve the problem or resolves the problem themselves.
System fails to connect to IID Receive Server
   1. Error is logged

### EXAMPLE 42

### Create DICOM Destination

This example describes the process of creating a DICOM Destination using the IID Configuration tool.
   Pre-Conditions
System has a working network connection.
   Post-Conditions
System is connected to all IID Receive Servers.
   Basic Flow
1. QC Tech Assistant expands DICOM Destination Configuration list.
2. QC Tech Assistant clicks the Add button.
3. QC Tech Assistant types in the DICOM destination information.
4. System creates the DICOM destination.
   Alternative Flows
Unable to Connect to an IID Receive Server
   Network connection is unavailable.
      1a. QC Tech Assistant alerts an IT contact to resolve the problem or resolves the problem themselves.
System fails to connect to IID Receive Server
   1. Error is logged

### EXAMPLE 43

### Create User

This example describes the process of creating a user using the IID Configuration tool.
   Pre-Conditions
System has a working network connection.
   Post-Conditions
System is connected to all IID Receive Servers.
   Basic Flow
1. QC Tech Assistant expands User Configuration list.
2. QC Tech Assistant clicks the Add button.
3. QC Tech Assistant types in the user information.
4. System creates the user
   Alternative Flows
Unable to Connect to an IID Receive Server
   Network connection is unavailable.
      1a. QC Tech Assistant alerts an IT contact to resolve the problem or resolves the problem themselves.
System fails to connect to IID Receive Server
   Error is logged

### EXAMPLE 44

### Delete DICOM Destination

This example describes the process of deleting a DICOM Destination using the IID Configuration tool.
   Pre-Conditions
System has a working network connection.
   Post-Conditions
System is connected to all IID Receive Servers.
   Basic Flow
1. QC Tech Assistant expands DICOM Destination Configuration list.
2. QC Tech Assistant selects the DICOM destination to remove.
3. System deletes the selected DICOM destination.
   Alternative Flows
Unable to Connect to an IID Receive Server
Network connection is unavailable.
   1a. QC Tech Assistant alerts an IT contact to resolve the problem or resolves the problem themselves.
System fails to connect to IID Receive Server
   1. Error is logged

### EXAMPLE 45

### Delete User

This example describes the process of deleting a user using the IID Configuration tool.

Pre-Conditions

System has a working network connection.

Post-Conditions

System is connected to all IID Receive Servers.

Basic Flow

1. QC Tech Assistant expands User Configuration list.
2. QC Tech Assistant selects the user to remove.
3. System deletes the selected user.
   Alternative Flows
Unable to Connect to an IID Receive Server
   Network connection is unavailable.
      1 a. QC Tech Assistant alerts an IT contact to resolve the problem or resolves the problem themselves.
System fails to connect to IID Receive Server
   1. Error is logged

### EXAMPLE 46

### Edit DICOM Destination

This example describes the process of editing a DICOM destination using the IID Configuration tool.
   Pre-Conditions
System has a working network connection.
   Post-Conditions
System is connected to all IID Receive Servers.
   Basic Flow
1. QC Tech Assistant expands DICOM Destination Configuration list.
2. QC Tech Assistant clicks on the DICOM destination they wish to open.
3. System opens the destination and displays the destination information in the window on the right side of the application.
4. QC Tech Assistant can modify the destination fields: description, hostname, AE title, port, and user.
5. System saves any modifications to the destination.
   Alternative Flows
Unable to Connect to an IID Receive Server
   Network connection is unavailable.
      1a. QC Tech Assistant alerts an IT contact to resolve the problem or resolves the problem themselves.
System fails to connect to IID Receive Server
   1. Error is logged

### EXAMPLE 47

### Edit User

This example describes the process of editing a user using the IID Configuration tool.
   Pre-Conditions
System has a working network connection.
   Post-Conditions
System is connected to all IID Receive Servers.
   Basic Flow
1. QC Tech Assistant expands User Configuration list.
2. QC Tech Assistant clicks on the user they wish to open.
3. System opens the user and displays the user information in the window on the right side of the application.
4. QC Tech Assistant can modify the user field: display.
5. System saves any modifications to the user.
   Alternative Flows
Unable to Connect to an IID Receive Server
   Network connection is unavailable.
      1a. QC Tech Assistant alerts an IT contact to resolve the problem or resolves the problem themselves.
System fails to connect to IID Receive Server
   Error is logged

### EXAMPLE 48

### Open DICOM Destination

This example describes the process of opening a DICOM Destination using the IID Configuration tool.
   Pre-Conditions
System has a working network connection.
   Post-Conditions
System is connected to all IID Receive Servers.
   Basic Flow
1. QC Tech Assistant expands DICOM Destination Configuration list.
2. QC Tech Assistant clicks on the DICOM Destination they wish to open.
3. System opens the DICOM Destination and displays the destination information in the window on the right side of the application.
   Alternative Flows
Unable to Connect to an IID Receive Server
   Network connection is unavailable.
      1a. QC Tech Assistant alerts an IT contact to resolve the problem or resolves the problem themselves.
System fails to connect to IID Receive Server
   1. Error is logged

### EXAMPLE 49

### Open User

This example describes the process of opening a user using the IID Configuration tool.
   Pre-Conditions
System has a working network connection.
   Post-Conditions

System is connected to all IID Receive Servers.

Basic Flow

1. QC Tech Assistant expands User Configuration list.
2. QC Tech Assistant clicks on the user they wish to open.
3. System opens the user and displays the destination information in the window on the right side of the application.
   Alternative Flows
Unable to Connect to an IID Receive Server
   Network connection is unavailable.
      1 a. QC Tech Assistant alerts an IT contact to resolve the problem or resolves the problem themselves.
System fails to connect to IID Receive Server
   Error is logged
      HawkNet

On aspect of the invention, HawkNet, may be used an application level protocol built upon the user datagram protocol. In some embodiments, HawkNet facilitates high volume flow needed for transferring data across large distances. In some embodiments, HawkNet may provide high utilization of bandwidth through its congestion control algorithm. In some embodiments, HawkNet may be implemented entirely using the latest Java technology, which provides cross platform compatibility.

HawkNet may combine the speed of user datagram protocol (UDP) transmission and reliability of the popular transmission control protocol (TCP). Performance with the HawkNet protocol may be faster than TCP, and more reliable than UDP. In some embodiments, HawkNet's congestion control mechanism may maintain efficiency, fairness and stability, and in some embodiments, its application-level nature may enable it to be deployed at low cost, without any changes in the network infrastructure or operating systems.

Hawk Net may be a method of transmitting streams of data from an application on one computer to another via the internet. This may be accomplished by providing a custom protocol framework and custom congestion control algorithm. The Hawk Net may provide a protocol framework for the transmission of UDP packet. This framework may be required for ensuring that packets are sent and received in order, and reconstructing the individual packets to and from their original data stream. Congestion control may tune the packet sending rate based upon a calculation of the estimated link capacity. Tuning the transmission of packets may also be based upon a rate control equation. Flow control may limit the amount of unacknowledged packets. Flow control may time the packet arrival intervals, run it through the flow control equation, and determine the window size to receive. Then it may be then sent back via an ACK packet. Hawk Net may use the bandwidth most efficiently. Because Hawk Net may not a connection based protocol, it may be used to send to a computer that uses multiple IP Addresses, and therefore increase the speed. Hawk Net's protocol framework and congestion control may allow an application to make the most of the available bandwidth, especially when multiple connections are available. This may be due to the fact that a host can receive the same stream on multiple IP addresses from a remote computer.

Two major aspects of an internet protocol may be its protocol framework and congestion control framework. HawkNet may define both of these frameworks. HawkNet provides to its end user (computer application) a method of sending data over a network. The typical network that HawkNet sends data over is the internet. FIG. 15 illustrates how an user (application) views HawkNet. The user sees HawkNet as a method of communicating data over the internet to another user. All the user has to do to use HawkNet is to know what other user to send to, and then use HawkNet by setting its input stream. The input stream is simply the binary data that the user wants to send to the other user. FIG. 15 also shows an important property of HawkNet, it has multiple connections to the internet.

The protocol framework may define the tools that make up the protocol, it may be the foundation of the protocol. The protocol framework may define packets, and operations on packets in order to setup a method of communication where there are expected methods of sending and receiving data, similar to the definition of a language. There may be expected ways of communication in the English language, and likewise the protocol may define a method of communication. Congestion control may be the intelligence behind the protocol, and the controller of the protocol. Congestion control may be an intelligent way of limiting the rate at which packets are sent

A HawkNet socket is what is available to an application that uses the HawkNet protocol. From an application's perspective, a HawkNet socket may be an object that can send and receive data, similar to a telephone, it can send and receive data. The data a HawkNet socket may receive and send are binary streams of data that are sent and received from the computer's Ethernet adaptor. These streams may be characterized as output and input streams. For an application to send data using a HawkNet socket, it may simply need to set its input stream as well as whom to send to. The input stream may simply be the binary data to be sent, and an IP Address is the required for whom to send to. Output streams may contain the binary data that was received from an input stream.

Streams are sent over the internet in what may be called packets. Packets may represent a collection of bytes in which their order is defined. Packets may have two main sections, a header and data section. The data section may simply a pre-defined number of bytes that typically are from the input stream. A header may represent metadata of the data section. Most of the header may be actually added by the underling network architecture (such information like the sender and receiver's IP Addresses). Certain packet types may be defined in HawkNet in order to allow for differing communications. There may be really two types of packets, command and data. Start, stop, acknowledgement, and negative acknowledgement may be considered command packet that are used to tell HawkNet that a certain action must be performed. Data packets may simply contain a known amount of data bytes. All HawkNet packets may contain a packet type as the first byte in the packet's header. The packet type may allow a receiver to quickly read the packet type, and perform the correct operation upon the packet.

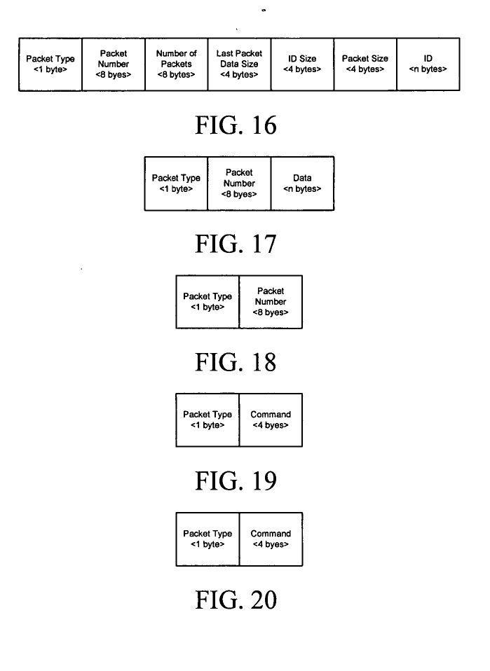

FIG. 16 depicts one kind of start packet. Start packets may be the first packets that are sent, and may contain information about the input stream that has been packetized. Since the start packet may be the first packet, its type and packet number are 0. The last packet data size may be included as the next field in the header, and may be necessary because the last data packet may not completely fill the packet. The ID size may be used to let the Depacketizer know how long the ID is. Next, the packet size may define the size to be expected for all coming packets that are from the same stream. Lastly, the ID may be a unique identified that is included to identify the input stream.

FIG. 17 depicts one kind of data packet. The data packet may be identified by its packet type and packet number in order for the Packetizer to reconstruct the input stream. The data may be a sequence of bytes from the input stream where the number of bytes is defined in the start packet.

FIG. 18 depicts one kind of data packet. The stop packet may serve the purpose of letting the receiver know when to stop listening for more packets from the same input stream, and also let the Depacketizer know when to stop.

FIG. 19 depicts one kind of acknowledgement (ACK) packet. The acknowledgement packet may be used in flow control in order to trigger a resize or move of the flow control window. ACK packets may carry arrival speed information back in the command section.

FIG. 20 depicts one kind of negative acknowledgement (NACK) packet. Negative acknowledgment packets may carry commands to resend lost if retransmission is not received in an increasing time interval.

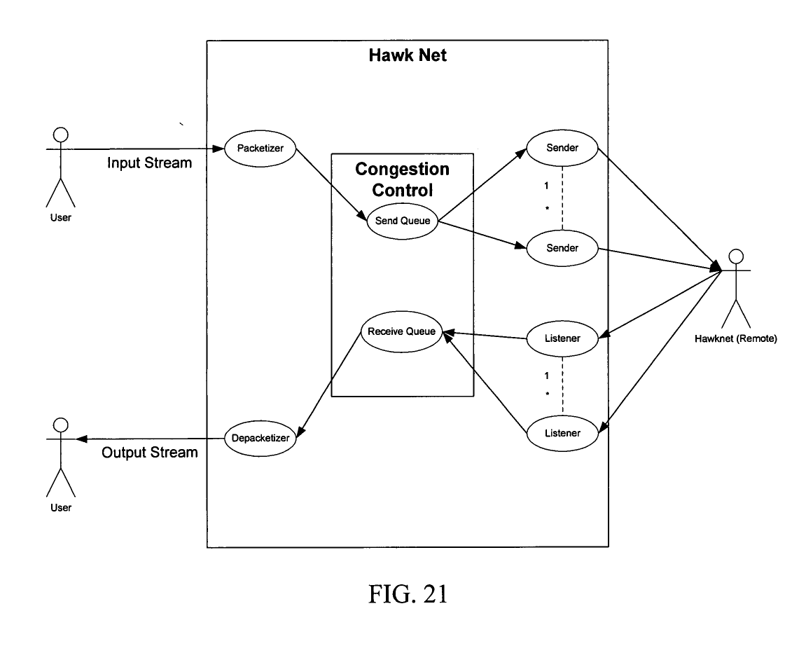

FIG. 21 depicts a diagram of one embodiment of HawkNet.
Listeners
   Listeners may be simply UDP sockets that are spawned and Controlled by Listener controllers. A Listener's job may be to wait and receive packets until its controller tells it to stop.
Senders
   Senders may be simply UDP sockets that are spawned and controlled by Sender Controllers. A Sender's job may be to wait for packets to send and send them until its controller tells it to stop.
Listener Controllers
   Listener Controllers may spawn Listeners to wait for incoming packets, and remove the Listeners when they are no longer needed. They also may receive both ACK and NACK packet used in congestion control.
Sender Controllers
   Sender Controllers may spawn Senders to send packets in the send queue. The Sender Controller may manage the senders used to send packets, thus accomplishing multiple connections to the internet. Senders may be removed when they are no longer needed.

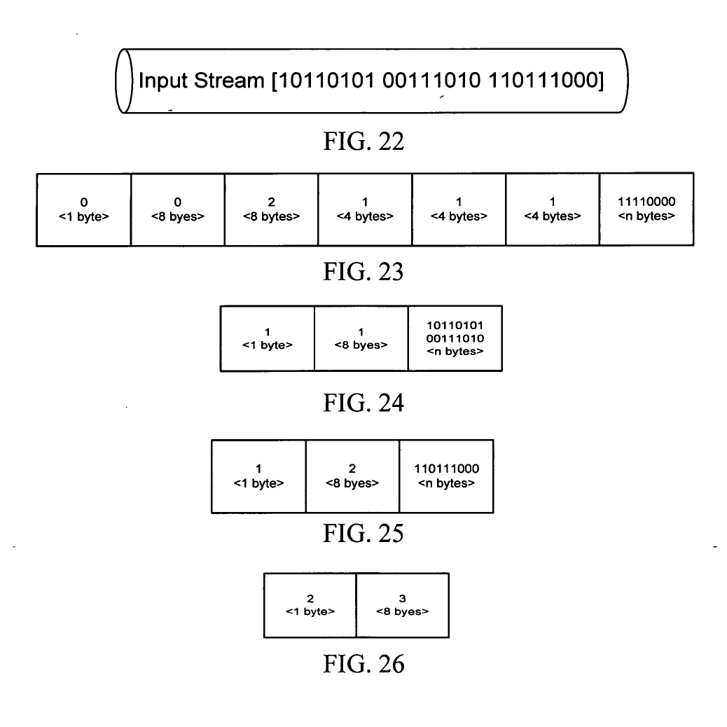

In some embodiments, one of the HawkNet protocol framework's tools is the Packetizer. The Packetizer's job may be to convert an input stream into packets, and prepare those packets to be sent. The Packetizer may write the header for each packet and ensure proper ordering of packets before they are sent. The follow is an example of how the Packetizer breaks up an input stream into packet. FIG. 22 shows the input stream that is passed to HawkNet by a user, and contains three bytes of data that will be packetized. The input stream (FIG. 22) contains three bytes, so a total of four packets will be made given that the packet size is two byte, and ID is 11110000. FIG. 23 shows the start packet's contents along with the given ID. The first data packet is shown in FIG. 24, and contains a total of two data bytes, which was the packet size defined in the start packet. FIG. 25 shows the second and last data packet. It contains a total of one byte of data, which, again, was specified in the start packet's last packet data size field. The stop packet (FIG. 26) is the last packet, and contains no useful data

The Packetizer may ensure that the input stream is broken up sequentially by writing a packet sequence number to the packet's header. This later may allow the Depacketizer to build the output stream as the packets are received. By including packet types in a packet's header commands may be differentiated from normal data packets. The packet header may be required to make sense of the packet's data.

Depacketizer's sole job may be to undo what the Packetizer has done to the input stream and form an output stream. That is, packets may be read from the receive queue sequentially by the Depacketizer, removes the packet header, and writes the data section of the packet to the output stream. The Depacketizer may get a hint to stop when it reads the stop command packet. The send queue may be where all the packets are placed by the Packetizer and wait to be sent. The receive queue may be where newly received packets are placed as they wait for the Depacketizer to convert them back into the output stream.

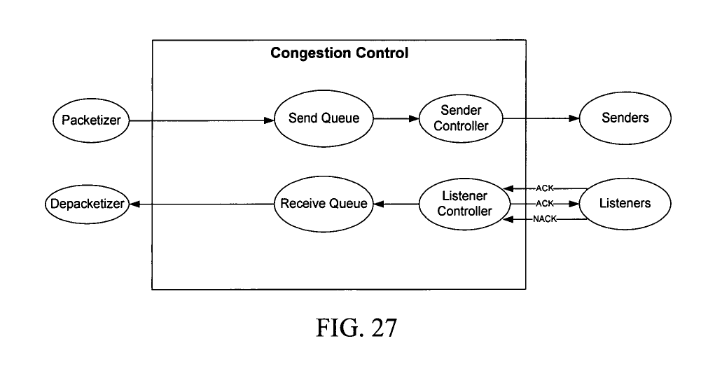

FIG. 27 shows a detailed view of the congestion control shown in figure seven. It shows the path of packets as they are placed in the send queue, scheduled to be sent by the sender controller, and sent by the senders. It also shows the path of packets as packets are passed to the Listener Controller by the Listeners. The Listener Controller may monitors the ACK's and NACK's received, and inform the rate control and flow control.

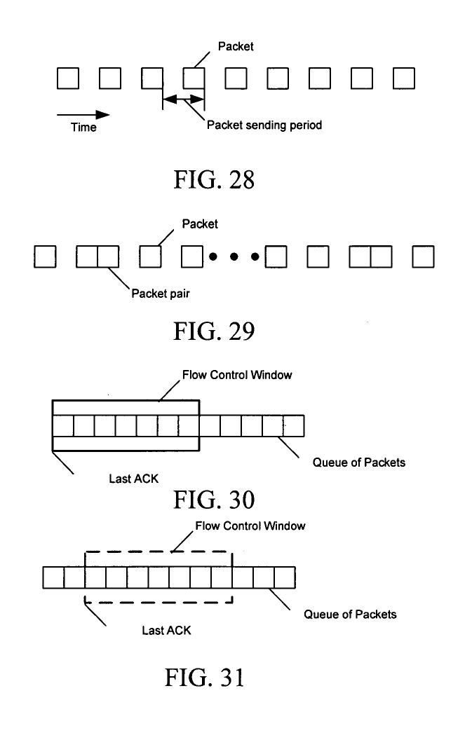

Rate control may tune the packet sending period and is triggered at a constant periodic rate. FIG. 28 shows packet time periods as they are being sent. It may be governed by the following equation.

$$INC = max ( {10}^{{log}_{10} ( 8 ( B - C ) ( MTU ) )} \frac{β}{MTU} , \frac{1}{MTU} )$$

Where the following variables are defined as:
MTU
   The maximum transmission unit in bytes, which is the same as the UDT packet size.
B
   The estimated bandwidth.
C
   The current sending rate.
β
   β is a constant value of 1.5×10⁻⁶ bytes.
INC
   the number of packets that will be sent in the next ACK timer period

The link capacity may be a value calculated by sending two packets one right after the other; these are called packet pairs. When these packet pairs are received, the receiver may use a median filter on the interval between the arrival times of each packet pair to estimate link capacity. FIG. 29 shows packets as they are being sent, including packet pairs. The sending rate may be determined by the rate control equation, which calculates the number of packets to be increased in the next period of rate control. The decrease factor may be determined when a NACK packet is received only if the last lost packet is the most recent or if the number of lost packets goes beyond a predefined threshold.

FIG. 30 is an example of the flow control window and the queue of packets to be sent. The flow control window may limit the number of unacknowledged packets by controlling the amount of available packets that can be sent by moving and resizing the window according to the last ACK that was received. FIG. 31 shows another example of the flow control window after it has received an ACK packet, the window may grow and move to allow more packets to be sent. Flow control limits the number of unacknowledged packets and is triggered when an ACK packet is received.

The flow control equation:
W=0.875W+0.125(RIT+SYN)(AS)

Where the following variables are defined as:
W
   The size of the flow window.
AS
   The packet's arrival speed at the receiver side, the receiver records the packet arrival intervals, AS is calculated from the average of latest 16 intervals after a median filter.
RTT
   Round Trip Time. A measure of the delay between hosts. Consists of the time taken for a single packet to leave one machine, reach the other and return.
SYN
   Rate control tunes the inter-packet time at every constant interval (ACK timer period), which is called SYN. The value of SYN is 0.01 seconds, an empirical value reflecting a tradeoff among efficiency, fairness and stability.

Another embodiment of the present invention includes a system such as one referred to herein as HawkNet, which is a method and system for transmitting streams of data from an application on one computer and/or server to another via the internet or network. HawkNet, for example, provides a custom protocol framework and a custom congestion control algorithm. HawkNet's custom protocol framework ensures that packets may be sent and received and reconstructed in the proper order. HawkNet's congestion control algorithm may tune the packet sending rate based upon a calculation of the estimated link capacity. Tuning the transmission of packets may also be based upon a rate control equation. Flow control may limit the amount of unacknowledged packets. Flow control may also time the packet arrival intervals, runs the packet arrival interval through the flow control equation, and determines the window size to receive. Flow control data may then be sent back via an acknowledgement (ACK) packet.

HawkNet may also be used with computers and servers with use multiple IP addresses. HawkNet's protocol framework and congestion control may also allow an application to make the most of the available bandwidth, especially when multiple connections are available. A host may receive parts of the same stream on multiple IP addresses from a remote computer.

Two aspects of an internet protocol are the protocol framework and congestion control framework. In one embodiment, HawkNet can define both of these frameworks. HawkNet may provide to its end user (computer application) a method of sending data over a network. The preferable network that HawkNet sends data over, for example, may be the internet. FIG. 15 illustrates how a user (application) views HawkNet. The user, for example, sees HawkNet as a method of communicating data over the internet to another user. In order to send data to another user the present user need only communicate an input data stream and the location of the other user to HawkNet. The input data stream may simply be binary data that the user wants to send to another user. FIG. 15 also shows the multiple connections HawkNet may have to the internet in specific embodiments.

HawkNet Protocol Framework

TCP may be a reliable protocol, but may become inefficient as network bandwidth and delays increase. This problem may be due to slow loss-recovery, a RTT bias inherent in its AIMD congestion-control algorithm, and the bursting data flow caused by its window control. Modern applications that are data intensive applications over high bandwidth delay product (BDP) networks, such as computational grids, need new transport protocols to support them.

Transmission Control Protocol (TCP) may be a stream-based method of network communication. TCP focuses on establishing a connection to control order of packets, and packet loss. TCP uses a lower level communications protocol, the Internet Protocol (IP), to establish connection between two machines. The connection provides an interface that allows a stream of bytes to be sent and received, and transparently converts the data into IP datagram packets.

A user datagram protocol is a commonly used transport protocol. UDP is a connectionless protocol, meaning that it doesn't guarantee packet delivery or that packets arrive in sequential order. UDP has the advantage of lower overhead than TCP streaming protocols, and can be used to saturate available network bandwidth to deliver large amounts of data. UDP sockets can receive data from more than one host machine, making it more convenient than TCP.

HawkNet, for example, may be used as an internet transport protocol implemented over UDP, meant as a better replacement of TCP. TCP's legacy design carries a number of inefficiencies, for example, TCP's inability to utilize most modern links' bandwidth. This problem stems from the fact that TCP calculates the congestion of the channel based on round-trip time. The round-trip time, however, reflects not only the congestion level, but also the physical length of the connection. This is precisely why TCP may be inherently unable to reach optimal speeds on long high-bandwidth connections.

HawkNet, in one embodiment of the present invention, is a method of transmitting streams of data from an application on one computer to another via the internet. This may be accomplished by providing a custom protocol framework and methods that perform a unique custom congestion control algorithm.

HawkNet provides a protocol framework for the transmission of UDP packet. This framework may be required for ensuring that packets may be sent and received in order, and reconstructing the individual packets to and from their original data stream.

Congestion control may, in one embodiment, tune the packet sending rate based upon a calculation of the estimated link capacity. Tuning the transmission of packets may also be based upon a rate control equation. Flow control limits the amount of unacknowledged packets. Flow control times the packet arrival intervals, runs it through the flow control equation, and determines the window size to receive. Then it is, then sent back via an ACK packet.

HawkNet may also use the bandwidth most efficiently. Because HawkNet may not be a connection based protocol, it can be used to send to a computer that uses multiple IP Addresses, and therefore increase the speed.

HawkNet's framework and congestion control may, for example, allow an application to make the most of the available bandwidth, especially when multiple connections may be available. Because a host can receive the same stream on multiple IP addresses from a remote computer the available bandwidth increases and more data may be sent.

The protocol framework may define the tools that make up the protocol; serving as the foundation of the protocol. The protocol framework defines packets and operations on packets in order to setup a method of communication where expected methods of sending and receiving data exist. This framework is similar to the definition of a language. Just as there are expected ways of communication in the English language, likewise the protocol defines a method of communication.

Congestion Control

In one embodiment of the present invention the congestion control may be the intelligence behind the protocol, and the controller of the protocol. Congestion control may be an intelligent way of limiting the rate at which packets are sent.

In one specific embodiment, a HawkNet socket may be what is available to an application that uses the HawkNet protocol. For example, from an application's perspective, a HawkNet socket may be an object that can send and receive data. The data HawkNet sockets receives and sends are binary streams of data that may be sent and received from the computer's Ethernet adaptor. These streams may be characterized as output and input streams.

For an application to send data using a HawkNet socket, the application simply needs an input stream and information about who to send the stream to. For example, the input stream may be binary data and an IP Address. Output streams contain the binary data that was received from an input stream.

Data streams may be sent over the internet in what are called packets. Packets may be a collection of bytes with a defined order. Packets preferably have two main sections, a header and a data section. The data section, for example, may be a pre-defined number of bytes that may preferably be from the input stream. A header represents metadata from the input stream. Most of the header is actually added by the underling network architecture and may include, for example, such information as the sender and receiver's IP Addresses. Certain packet types may be defined in HawkNet in order to allow for differing communications. In one embodiment of the present invention there may be two types of packets, command and data packets. For example, start, stop, acknowledgement, and negative acknowledgement may be considered command packets that may be used to tell HawkNet that a certain action can be performed. Data packets simply contain a known amount of data bytes. All HawkNet packets contain a packet type as the first byte in the packet's header. The packet type allows a receiver to quickly read the packet type, and perform the correct operation upon the packet.

In another embodiment, start packets may be the first packets sent, and may contain information about the input stream that has been packetized. For example, its type and packet number may be 0. The last packet data size may be included as the next field in the header, and may be necessary because the last data packet may not completely fill the packet. The ID size may be used to let the Depacketizer know how long the ID is. Next, the packet size defines the size to be expected for all coming packets that may be from the same stream. Lastly, the ID may be a unique identified that may be included to identify the input stream. FIG. 16 is a visual representation of an exemplary start packet.

The data packet, for example, may be identified by its packet type and packet number in order for the packetizer to reconstruct the input stream. The data may be a sequence of bytes from the input stream where the number of bytes may be defined in the start packet. FIG. 17 is a visual representation of an exemplary data packet.

The stop packet may serve the purpose of letting the receiver know when to stop listening for more packets from the same input stream. The stop packet may also let the Depacketizer know when to stop. FIG. 18 is a visual representation of an exemplary stop packet.

The acknowledgement packet may be used in flow control in order to trigger a resize or move of the flow control window. ACK packets may, for example, carry arrival speed information back in the command section. FIG. 19 is a visual representation of an exemplary ACK packet.

Negative acknowledgment (NACK) packets may carry commands to resend lost packets. When depacketizing a data stream, the depacketizer will reassemble the packets according to the data packet number. If a packet number is missing, a NACK packet is sent requesting the data packet be resent. FIG. 20 is a visual representation of an exemplary NACK packet.

FIG. 21 depicts one embodiment of the HawkNet system. This embodiment comprises a packetizer, send queue, a plurality of senders, a plurality of listeners, a receive queue, and a depacketizer. In order to send data across a network the user, for example, sends a binary data stream to the packetizer which deconstructs the data stream and places the data into packets as well as creates control packets. The packets as they are created may be stored in the send queue. When packets arrive in the send queue the senders send the packets across the network. In order to receive data the listeners receive packets and places the received packets in the receive queue. The packets in the receive queue may then be depacketized by the depacketizer and sent out as an output stream.

In yet another embodiment, listeners may be UDP sockets that are spawned and Controlled by Listener controllers. A Listener waits and receives packets until its controller tells it to stop. Senders may be UDP sockets that are spawned and controlled by Sender Controllers. A Sender waits for packets to send and sends them until its controller tells it to stop. Listener Controllers, for example, may spawn Listeners to wait for incoming packets, and may remove the Listeners when they are no longer needed. They also receive both ACK and NACK packet used in congestion control. Sender Controllers, for example, spawn Senders to send packets in the send queue. The Sender Controller manages the senders used to send packets, thus accomplishing multiple connections to the internet. Senders may be removed when they are no longer needed.

In another embodiment, the Packetizer converts an input stream into packets, and prepares those packets to be sent. The Packetizer writes the header for each packet and ensures proper ordering of packets before they may be sent. The Packetizer may break an input stream into packets: FIG. 24 shows an input stream that is passed to HawkNet by a user. Notice that this example stream contains three bytes of data. If, for example, the packet length is 2 bytes then at least 4 packets are created. FIG. 23 shows an exemplary start packet for the data stream shown in FIG. 22. FIG. 24 shows an exemplary first data packet that contains the first two bytes. FIG. 25 shows an exemplary second data packet.

In another embodiment, the Packetizer may ensure that the input stream is broken up sequentially by writing a packet sequence number to the packet's header. This allows the Depacketizer to build the output stream as the packets are received.

By including packet types in a packet's header commands may be differentiated from normal data packets. The packet header can thereby make sense of the packet's data.

In another embodiment, the depacketizer's sole job is to undo what the Packetizer has done to the input stream and form an output stream. For example, packets are read from the receive queue sequentially by the Depacketizer, the packet header is removed, and the data section of the packet is written to the output stream. The Depacketizer may stop when it reads the stop command packet.

In a further embodiment, the send queue may be where all the packets are placed by the Packetizer and wait to be sent. The receive queue may be where newly received packets are placed as they wait for the Depacketizer to convert them back into the output stream.

Congestion Control

FIG. 27 shows a detailed view of the congestion control shown in FIG. 21. For example, it shows the possible path of packets as they are placed in the send queue, scheduled to be sent by the sender controller, and sent by the senders. It also shows the path of packets as packets may be passed to the Listener Controller by the Listeners. The Listener Controller monitors the ACK's and NACK's received, and informs the rate control and flow control.

In another embodiment the rate control tunes the packet sending period and may be triggered at a constant periodic rate. FIG. 28 shows packet time periods as they are being sent. The rate control may be governed by the following equation:

$$INC - max ( {10}^{{log}_{10} ( 8 ( B - C ) ( MTU ) )} \frac{β}{MTU} , \frac{1}{MTU} )$$

Where MTU is the maximum transmission unit in bytes, which may be the same as the UDT packet size. B is the estimated bandwidth. C is the current sending rate and β is a constant value of 1.5×10⁶ bytes. INC is the number of packets that may be sent in the next ACK timer period.

In another embodiment, the link capacity may be a value calculated by sending two packets one right after another called packet pairs. When these packet pairs may be received, the receiver uses a median filter on the interval between the arrival times of each packet pair to estimate link capacity. FIG. 29 shows packets as they are being sent, including packet pairs.

The sending rate may be determined by the rate control equation, which calculates the number of packets to be increased in the next period of rate control. The decrease factor may be determined when a NACK packet is received only if the last lost packet is the most recent, or if the number of lost packets goes beyond a predefined threshold.

FIG. 30 is an example of the flow control window and the queue of packets to be sent. The flow control window limits the number of unacknowledged packets by controlling the amount of available packets that can be sent by moving and resizing the window according to the last ACK that was received. FIG. 31 shows another example of the flow control window after it has received an ACK packet, the window grows and moves to allow more packets to be sent;

In yet another embodiment, the flow control limits the number of unacknowledged packets and may be triggered when an ACK packet is received.

In another embodiment, the data may be transmitted and received from the network through multiple links. Sending data in parallel across the network through multiple links decreases the transmission time for a set of data. This embodiment may only occur when both the transmitting and receiving servers and computers have multiple ports. First an initialization packet is transmitted, initializing one of potentially many links. A return initialization packet in response may be returned containing information about the bandwidth, the receive link past history, number of receive links used in the past, the network, and speeds. This return packet informs the transmission server about the potential for multiple links. Using this information, additional links may be initialized. Once multiple links have been initialized parallel data may be sent speeding up transmission time.

The HawkNet embodiment may use acknowledgement (ACK) packets to inform the transmission unit concerning success or lack of success in transmitting a data packet as well information about transmission time of a data packet. When a receive unit receives a data packet, an ACK packet may be sent, in response to the data packet, to the transmission unit. An exemplary ACK packet is shown in FIG. 19. The packet contains the packet number of the received packet thus confirming receipt of the data packet. If the transmission unit does not receive an ACK packet, another data packet may be sent. The TCP protocol requires receipt of the ACK packet prior to sending the next data packet. In one embodiment of the present invention, data packets may be sent in accordance with a flow and congestion control algorithm based on network and system characteristics. The system may not wait for an ACK packet to send the next packet. The flow may not be regulated solely on ACK packet reception. Rather, an algorithm may be used to calculate the optimum flow window and timing. The system uses ACK packets to confirm receipt of specific data packets. If an ACK packet is not received that data packet may be retransmitted.

The data rate may be adjusted through a learning algorithm that may be a function of elements selected from the group comprising of the receiving buffer size, packet loss, estimated bandwidth, current sending rate, number of packets sent during the next ACK timer, round trip time, arrival speed, size of the flow control window, packet size, negative acknowledgment packets (NACK), and bandwidth and buffer size.

An exemplary flow control equation:
W=0.875W+0.125(RTT+SYN)(AS)

Where W is the size of the flow window. AS is the packet's arrival speed at the receiver side, the receiver records the packet arrival intervals, AS is calculated from the average of latest 16 intervals after a median filter. RTT is the Round Trip Time: A measure of the delay between hosts and includes the time taken for a single packet to leave one machine, reach the other and return. SYN is the rate control tunes the inter-packet time at every constant interval (ACK timer period), which is called SYN. The value of SYN may be 0.01 seconds, an empirical value reflecting a tradeoff among efficiency, fairness and stability.

Radiology Software Implementation

In a specific embodiment of the present invention, the many systems, methods, and apparatus may be used in a radiology services system. NightHawk Radiology Services provide such a service. This radiology services system provides around the clock radiology services to the medical community. The system maintains a system for sending DICOM radiology studies to waiting radiologists around the world for diagnosis and return. Embodiments of the present invention may be employed to implement such a system. This system includes a number of modules detailed below.

Online Order Entry Module

Online Order Entry module may be a web based order entry and order tracking website accessible from any where in the world. It may be protected with secure login and via Verisign's SSL certificate. After login, the customer has the ability to place an order by filling out all required information including: Patient Name, Hospital's Unique Patient medical Record Number (MRN), Age of patient, Patient location, Patient primary caregiver, Number of Medical Images in the study, Type of Modality (e.g., CT, MRI, X-ray, NucMed, UltraSound), Priority (Major Trauma), Patient History, Additional Notes, Alert for Additional Paperwork (which may have to be faxed manually), and Previous Study.

After submitting the order, the customer can then view the status of the order in real time as it is being processed, for example, by NightHawk. Once the study has been completed and the radiologist report sent, the customer can view the radiologist report online. Other functionality (depending on role) on the Online Order Entry website: Fax Details—Customer can view and modify fax information which an exemplary radiological software package's may use to fax; Report Archive—Customer can view all previous radiologist reports; Requisition Archive—Customer can view all previous orders placed online; Change Password; Manage Users; and NightHawk Contact Information. The initial status of the order upon submission may be “Online—Pre QC”

Fax Order Entry Module

If the customer does not utilize the Online Order Entry website, then NightHawk may accept a faxed order. This order may generally arrive on a customized NightHawk order requisition form, but it may not be required. The information may be identical to what may be required in the Online Order Entry (above) and should be accompanied with all the additional paperwork, such as Ultrasound worksheets.

The fax may be processed by, for example, NightHawk QC (Quality Control) personnel. The QC personnel may manually enter the patient and order information into the software using the “Add Study” screen. In one specific embodiment, the initial status of the order upon submission may be “Pre QC.”

Order Management Module

Upon saving a study or receiving an order via Online Order Entry, the study may be placed in a queue to be processed. The queue may be visible via a work list in the application. The queue may be sorted based on priority, time-in, and status and may be filtered based on user role.

Order Tracking Module

As soon as the order is placed into the system, a strict and detailed history may be kept on all activity relating to that order. The system, for example, may provide a series of statistic and historical reports for each study. If a study has been in the system without being placed in a “completed” state for an excessive amount of time, visible alerts may capture the attention of the user and alert them of that studies situation.

Exemplary radiological software also has the capabilities to locate any study ever processed by NightHawk and return to the user the history of the study, as well as the ability to view all accompanying documentation, including the radiologists completed report.

Order Entry Validation Module

The final step, for example, in the NightHawk QC process may be to validate the accuracy of the patient and study information. It may also be their responsibility to confirm that NightHawk has received a full set of medical images and that they may be in a satisfactory condition prior to assigning the order to the radiologists. A quick view of all images using IID DicomViewer tool to “Cine” through the image set may also be performed in order to ensure that the study has been prioritized appropriately. For example, if NightHawk has received a case that has obvious massive Trauma, yet the customer did not indicate Major Trauma on the order, the QC team may mark it as such and give it the highest priority. In one specific embodiment, the status of the order upon submission may now be “In QC”.

Assignment of Orders to Radiologist Module

The NightHawk QC may manually assign the order to a radiologist. However, exemplary radiological software may use a complex proprietary algorithm to “suggest” to the QC which radiologist should be assigned the study. One example of this algorithm is the Intelligent Image distribution discussed above. The QC does have the capability to override the suggestion, but may only be able to assign the study to a radiologist that has the appropriate credentials and licenses. Once the order is assigned, the study may now unlocked for the assigned radiologist and may appear in their work list. Specifically, the status of the order upon submission may now be “QC'd”.

Fax Order Confirmation Module

Once the NightHawk QC has validated the order and accepted the medical image set to be of satisfactory quality and assigns the study to a radiologist, an automated faxed order confirmation may be sent to all locations at the customer site that have requested the order confirmation. In a specific embodiment the status of the order remains “QC'd”.

Radiologist Report Entry Module

The radiologist works primarily in the RadView section of exemplary radiological software. The radiologist has a view of their own personal work list. The select the next study to read from the work list which in turn populates the main section of RadView with all patient and study information. The radiologist may be given the capabilities of editing this information. Once the radiologist may be prepared dictating their findings, they have 3 options from which to generate their report. First may be to select from a list of pre-defined macros usually used in studies with negative findings. Second may be to use third party voice recognition software and dictate the report. Third may be to physically type the report. Any combination of the above could also be used. The radiologist then saves the report.

In the event that the radiologist needs to add additional information to an already completed report that has been sent back to the customer, the original report cannot be modified. Automatically, an addendum may be created and associated to the original report and marked clearly as such. In a specific embodiment the status of the order upon selecting the study may be “In Reading”. In another embodiment the status of the order upon saving the study may be “Report Review”.

Radiologist Report Review Module

The NightHawk QC team has a separate work list which displays all reports that have been completed by the radiologist but not yet faxed back to the customer. The NightHawk QC may be responsible for double checking the report for typographical errors prior to sending final report to customer.

Radiologist Macro Management for common reports Module

Any NightHawk radiologist has the capabilities of creating their own personalized macros for common reports. These macros may be associated to a modality and exam type. For instance, if the radiologist may be working on a CT Abdomen, only those macros that have been created by that radiologist and associated to CT and Abdomen may be able to be selected.

Radiologist Report Auto-Generation in PDF format Module

Although the actual radiologist report may not be physically stored in the database as a PDF document, any time any user wishes to view the report it can be generated into PDF format on the fly

Radiologist Report Fax Management Module

At the time the customer may be created in the database, the customer may have the ability to choose which locations it would like to receive fax confirmations and radiologist reports. Also, the customer can indicate alternative fax numbers at the time or ordering.

Quality Assurance Management Module

In the event that a primary report issued by the customer differs from NightHawk radiologist's findings a Quality Assurance case may be opened. Such a system has the ability to track the opened case and assign it to the NightHawk radiologist who issued the NightHawk preliminary report. The radiologist's comments on the case may be stored and reported back to the customer.

Billing Corrections Management Module

There may be several circumstances in which the billing of a particular study needs to be adjusted. Although no data on the original study may be modified, a NightHawk Quality Assurance team member may enter the billing correction and reason for the correction.

Auto-Fax Custom Fax Order Entry Form Module

Each NightHawk customer may be issued their own customized order requisition form with their facilities name on it. For example, the Auto-Fax custom fax order entry form may be Auto-generated in the software system and then automatically faxed to the appropriate facility.

A mass fax which may automatically send a faxed announcement to all or a targeted group of NightHawk customers.

Radiologist Credentialing Management Module

Each of NightHawk's radiologists, for example, may have credentials or privileges to read for any hospital for which they are to provide radiology reports. The credentialing management section of the system allows appropriate NightHawk staff to, for example, modify the privilege status of any radiologist for any hospital. There may be instances when a radiologist has privileges at a hospital but may not be able to provide radiology services for that hospital. The credentialing management section further may allow the appropriate NightHawk staff to control whether or not to allow a radiologist to read for a hospital. All documents associated to the verification of the hospital privileges may be scanned and stored in the database and may be made available to view from within the application.

Radiologist State Licensing Management Module

Each of NightHawk's radiologists preferably maintains state licenses for each U.S. state that they are going to provide radiology services. The licensing management section of the system allows appropriate NightHawk staff to modify the state license status of any radiologist for any state. All documents associated to the verification of the state licenses may be scanned and stored in the database and may be made available to view from within the application.

Radiologist Scheduling Management Module

The various embodiments of the invention used in a radiology system may provide the ability to manage the scheduling of radiologist to ensure maximum coverage for NightHawk customers. Because not all radiologists have privileges at every hospital and all states, the scheduling of radiologists may allow the primary scheduler to input an initial schedule and instantly determine gaps of coverage and then make suggestions for schedule modifications.

Order Issue Resolution Tracking Module

The various embodiments of the invention used in a radiology system records all issues relating to any particular study. When an issue may be identified, NightHawk staff may create a case “ticket” and associate it to the study. The ticket may then be assigned to the appropriate NightHawk staff for follow up and issue resolution. The history of any given ticket may be viewable within the system application.

Technical Issue Resolution Tracking Module

The various embodiments of the invention used in a radiology system records all technical issues reported by our customers or NightHawk staff internally. The ticket may then be assigned to the appropriate NightHawk staff for follow up and issue resolution. The history of any given ticket may be viewable within the application.

Statistical Reporting Module

The various embodiments of the invention used in a radiology system may have numerous reports that have been requested over time. These reports may be protected via role based security protocols.

What is claimed is:

1. An intelligent image distribution system for transmitting data across a network comprising:
at least one proxy server;
at least one receive server; and
at least one cache server;
wherein said at least one proxy server communicates with at least one receive server across a network and said cache server communicates with said at least one receive server across a network;
wherein metadata, associated with data, is transmitted to a receive server from a proxy server; said receive server, based on said metadata, formulates at least one ideal cache server to transmit said data; said data is sent to said receive server; and said receive server transmits said metadata and said data to said at least one cache server.

2. The system of claim 1, wherein said data is a DICOM study.

3. The system of claim 1, wherein said proxy server communicates with at least one receive server across a network via transmission control protocol (TCP).

4. The system of claim 1, wherein said proxy server communicates with at least one receive server across a network via HawkNet protocol.

5. The system of claim 1, wherein said at least one receive server is located at a technology center.

6. The system of claim 5, wherein said technology center further comprises a plurality of receive servers.

7. The system of claim 5, wherein said technology center further comprises an internal cache server.

8. The system of claim 1 further comprising a client module.

9. The system of claim 1 further comprising an association module.

10. The system of claim 1 further comprising a configuration module.

11. The system of claim 1 further comprising a route module.

12. The system of claim 1 further comprising a status module.

13. The system of claim 1 further comprising a peer module.

14. The system of claim 1 further comprising a child module.

15. The system of claim 1 further comprising a study module.

16. The system of claim 1 further comprising an intelligence module.

17. The system of claim 8, wherein said metadata and data is transmitted to said proxy server from said client module.

18. The system of claim 8, wherein said metadata and data is transmitted directly to said receive server from said client module.

19. The system of claim 1 further comprising a destination module.

20. The system of claim 19, wherein said metadata and data is transmitted to said destination module via said cache server.

21. The system of claim 19, wherein said metadata and data is transmitted directly to said destination module.

22. The system of claim 1, wherein receive server formulates at least one ideal cache server to transmit said data by considering the following factors selected from the group comprising of: available destinations, number of links, bandwidth, latency, read speed, consistency, reliability, type, destination probability threshold, number of concurrent transfers, current utilized bandwidth, current observed latency, current read speed, current queue status, RIS work-list queue status, RIS work-list queue size, destination arbitrary weight factor, destination load factor, projected queue sizes, projected queue status, and projected system load.

23. The system of claim 1, wherein said metadata includes data selected from the list comprising slice ID, series ID, study ID, rescale slope, rescale intercepts, rescale type, patient name, description, study time, study data, receive time, study size, number of bytes, number of slices, intended destination, current location, transfer speeds, destination, clients, IP address, ports, title, destination name, destination ID, client name, and client id.

24. The system of claim 1, comprising more than one receive servers, wherein said receive servers are in communication with each other.

25. A method for determining the destination for delivering data comprising the step of formulating the probability available destinations may be assigned the data by considering factors selected from the group comprising: available destinations, number of links, bandwidth, latency, read speed, consistency, reliability, type, destination probability threshold, number of concurrent transfers, current utilized bandwidth, current observed latency, current read speed, current queue status, RIS work-list queue status, RIS work-list queue size, destination arbitrary weight factor, destination load factor, projected queue sizes, projected queue status, and projected system load.

26. The method of claim 25 wherein said data being delivered is a DICOM study.

27. A method for transmitting data across a network comprising:
receiving a binary data stream;
creating a start packet;
creating at least one data packet, wherein the number of data packets created is equal to rounding up the number of bytes in the binary data stream (N) divided by the packet size (n);
creating a stop packet, and
transmitting said start packet, said data packet, and said stop packet to an output socket.

28. The method of claim 27, wherein said start packet comprises:
a 1 byte value representing the current packet type;
a 8 byte value representing the packet number in said data stream;
a 8 byte value representing the number of packets in said data stream;
a 4 byte value representing the last packet size in said data stream;
a 4 byte value representing the ID size;
a 4 byte value representing the packet size (n); and
a m byte value representing the ID, wherein m is the value represented by the 4 byte ID size value.

29. The method of claim 27, wherein said data packet comprises:
a 1 byte value representing the current packet type;
a 8 byte value representing the packet number in said data stream; and
n bytes representing the data, wherein n is the value represented by the 4 byte packet size value in said start packet.

30. The method of claim 27, wherein said stop packet comprises:
a 1 byte value representing the current packet type; and
a 8 byte value representing the packet number in the data stream.

31. The method of claim 27 further comprising the step of receiving acknowledgement packets confirming receipt of each of said data packet.

32. A system for transmitting data across a network comprising:
a receiving module operative to receive a binary data stream;
a packetizing module operative to convert said binary data stream into packets comprising the steps of:
creating a start packet;
creating at least one data packet, wherein the number of data packets created is equal to rounding up the number of bytes in the binary data stream (N) divided by the packet size (n);
creating a stop packet, and
a transmitting module operative to transmit said start packet, said data packet, and said stop packet across a network.

33. The system of claim 32 further comprising a send queue.

34. The system of claim 32 further comprising a send controller.

35. The system of claim 32 further comprising senders.

36. The system of claim 32, wherein said start packet comprises:
a 1 byte value representing the current packet type;
a 8 byte value representing the packet number in said data stream;
a 8 byte value representing the number of packets in said data stream;
a 4 byte value representing the last packet size in said data stream;
a 4 byte value representing the ID size;
a 4 byte value representing the packet size (n); and
a m byte value representing the ID, wherein m is the value represented by the 4 byte ID size value.

37. The system of claim 32, wherein said data packet comprises:
a 1 byte value representing the current packet type;
a 8 byte value representing the packet number in said data stream; and
n bytes representing the data, wherein n is the value represented by the 4 byte packet size value in said start packet.

38. The system of claim 32, wherein said stop packet comprises:
a 1 byte value representing the current packet type; and
a 8 byte value representing the packet number in the data stream.

39. A computer-readable medium having computer-executable instructions for performing a method comprising:
receiving a binary data stream;
creating a start packet;
creating at least one data packets, wherein the number of data packets created is equal to rounding up the number of bytes in the binary data stream (N) divided by the packet size (n);
creating a stop packet, and
transmitting said start packet, said data packets, and said stop packet out an output socket.

40. A computer system, comprising:
a CPU;
memory;
a network interface; and
networking means for preparing HawkNet packets.

41. The computer system of claim 40, wherein the networking means further comprises:
means for transmitting packets across a network.

42. A computer system, comprising:
a CPU;
memory;
a network interface; and
networking means for receiving HawkNet packets.

43. The computer system of claim 42, wherein the networking means further comprises:
means for unpacking received HawkNet packets.

44. A method for transmitting a plurality of data packets out a network interface comprising the steps of:
creating at least one data packet;
transmitting a start packet;
transmitting said at least one data packet; and
transmitting a stop packet.

45. A computer system comprising:
CPU;
memory;
a network interface; and
means for communicating across a network with a protocol combines the high throughput of UDP data packets and the reliability of TCP data packets.

46. A computer system comprising:
CPU;
memory;
a network interface; and
a means for transmitting data across a network combines the high throughput of UDP protocol and the reliability of TCP protocol.

47. A method for receiving data from a network comprising:
receiving a start packet, receiving one or more data packets;
receiving a stop packet, wherein receipt of said stop packet ends the step of receiving data packets;
creating a binary data stream by ordering said data in said received data packets according to the packet number in said data packet; and
transmitting said binary data stream out an output socket.

48. The method of claim 47, wherein said start packet comprises:
a 1 byte value representing the current packet type;
a 8 byte value representing the packet number in said data stream;
a 8 byte value representing the number of packets in said data stream;
a 4 byte value representing the last packet size in said data stream;
a 4 byte value representing the ID size;
a 4 byte value representing the packet size (n); and
a m byte value representing the ID, wherein m is the value represented by the 4 byte ID size value.

49. The method of claim 47, wherein said stop packet comprises:
a 1 byte value representing the current packet type; and
a 8 byte value representing the packet number in the data stream.

50. The method of claim 47, wherein said data packet comprises:
a 1 byte value representing the current packet type;
a 8 byte value representing the packet number in said data stream; and
n bytes representing the data, wherein n is the value represented by the 4 byte packet size value in said start packet.

51. A computer-readable medium having computer-executable instructions for performing a method comprising:
receiving a start packet,
receiving one or more data packets;
receiving a stop packet, wherein receipt of said stop packet ends the step of receiving data packets;
creating a binary data stream by ordering said data in said received data packets according to the packet number in said data packet; and
transmitting said binary data stream out an output socket.

52. A system comprising:
a receiving module operative to receive data packets from a network;
a depacketizer module operative to convert data packets into a data stream; and
a transmitting module operative to output said binary data stream.

53. A computer system comprising:
a CPU;
memory;
a network interface; and
means for adjusting the data rate out a network interface through a learning algorithm that is a function of elements selected from the group comprising the receiving buffer size, packet loss, estimated bandwidth, current sending rate, number of packets sent during the next ACK timer, round trip time, arrival speed, size of the flow control window, packet size, negative acknowledgment packets (NACK) and bandwidth, buffer size.

54. A method for transmitting data across a network though multiple links comprising:
transmitting an initialization packet;
receiving a return initialization packet in response to said initialization packet containing information about the bandwidth, the receive link past history, number of receive links used in the past, the network, and speeds; and
setting up additional links based on information from said return initialization packet.

55. A method for receiving data from a network through multiple links comprising:
receiving a data stream;
creating packets from said data stream;
placing packets in a queue; and
transmitting packets through multiple links.

56. A method for receiving data transmitted across a network through multiple links comprising:
receiving a data packets;
transmitting an acknowledgement (ACK) packet in response to said data packet;
placing packets in a queue;
creating a data stream from said packets; and
transmitting said data stream.
